(19) United States
(12) Patent Application Publication
(10) Pub. No.: US 2013/0230036 A1
(43) Pub. Date: Sep. 5, 2013

(54) DEVICES AND METHODS FOR PRE-ASSOCIATION DISCOVERY IN COMMUNICATION NETWORKS

(71) Applicant: INTERDIGITAL PATENT HOLDINGS, INC., Wilmington, DE (US)

(72) Inventors: Alexander Reznik, Titusville, NJ (US); Joseph S. Levy, Merrick, NY (US); Shamim A. Rahman, Cote St. Luc (CA); Guodong Zhang, Syosset, NY (US); Juan Carlos Zuniga, Montreal (CA); Robert L. Olesen, Huntington, NY (US); Catherine M. Livet, Montreal (CA)

(73) Assignee: InterDigital Patent Holdings, Inc., Wilmington, DE (US)

(21) Appl. No.: 13/784,529

(22) Filed: Mar. 4, 2013

Related U.S. Application Data
(60) Provisional application No. 61/606,665, filed on Mar. 5, 2012.
(60) Provisional application No. 61/645,882, filed on May 11, 2012.
(60) Provisional application No. 61/701,298, filed on Sep. 14, 2012.
(60) Provisional application No. 61/701,335, filed on Sep. 14, 2012.
(60) Provisional application No. 61/751,595, filed on Jan. 11, 2013.

(51) Int. Cl. H04W 48/16

(52) U.S. Cl. CPC H04W 48/16
USPC 370/338

(57) ABSTRACT

Wireless transmit and receive units (WTRUs) and methods for pre-association discovery (PAD) are disclosed. The methods may include obtaining an IP address to communicate with a wireless local area network (WLAN) before associating with the WLAN for the purpose of performing PAD. The methods may include communicating with a remote information server (IS) by sending messages to the WLAN using an L2 address and receiving responses from the IS through the WLAN. The methods may include receiving a message including a source IP address from an unassociated WTRU and restricting the use of the source IP address by the unassociated WTRU. The methods may include receiving a PAD request from a WTRU and relaying messages between the WTRU and a remote IS for PAD information exchange. The WTRU may not have an IP address for use with the WLAN and the WTRU may not be associated with the WLAN.

### CROSS REFERENCE TO RELATED APPLICATIONS

This application claims the benefit of U.S. Provisional Application No. 61/606,665, filed on Mar. 5, 2012, U.S. Provisional application 61/645,882, filed on May 11, 2012, U.S. Provisional Application No. 61/701,298, filed on Sep. 14, 2012, U.S. Provisional Application No. 61/701,335, filed on Sep. 14, 2012, and U.S. Provisional Application No. 61/751,595, filed on Jan. 11, 2013, the contents of which are hereby incorporated by reference herein.

### BACKGROUND

Often a person or device would like a service from a network. For example, a user may be entering a new hotel for the first time, and may want to use a high-resolution color 3D printer to prepare materials for a sales meeting. The user's laptop computer may report that there are 6 wireless local area networks (WLANs) reachable by the user's laptop, but 5 may require payment or a user name and password before the user can determine whether or not the WLANs have a high resolution color printer. The sixth WLAN may be advertised as being a free network belonging to the hotel; however, the user may be unsure whether or not the network really belongs to the hotel and is secure. The user may want to know which of the WLANs has a high-resolution color printer, but may not want to logon to a WLAN first or provide credit card information prior to knowing whether the WLAN has a high-resolution color printer and possibly what the cost would be to use the printer.

In a second example, a user may want to watch on a device sports events while traveling. The user may want to watch free edited highlights, or pay for a high quality match. However, the user's current mobile operator may not allow either of these services to be streamed to the user's device. There may be many other networks that the user's device could attach to, but the user does not want to attach to each of the networks to find out which video services are available on the different networks. The reason the use may not want to attach to the different network is that to attach to a network may take time and cost money. Additionally, the user may be unsure whether or not to trust the network.

In a third example, a user may be roaming and may not want to use a cellular connection for their data connection. The user may wish to download a significant amount of data for a short time or the user may wish to use a VoIP service. Networks that are reachable by the user's device may provide an indication of their data connection capabilities, or preferences, but not until the user has attached to the network.

In a fourth example, a user may want to use an electronic book application to access a new online electronic book. The electronic book service provider may pay for access to the electronic book across a local network; however, the device may need to discover which networks have a contract with the electronic book service provider for the access to the electronic book to be free to the user. Alternatively, a user may want to make a telephone call but their telephone network may not be available; however, there may be other networks available. The telephone network may provide free access for telephone calls using other networks, but only if the user's device can determine the least cost alternative network to use.

Therefore, there is a need in the art for devices to be able to perform pre-association discovery (PAD) to determine services offered by networks without having to associate with the network.

### SUMMARY

Wireless transmit and receive units (WTRUs), and methods for the purpose of performing pre-association discovery (PAD) are disclosed. The methods may include obtaining an IP address to communicate with a wireless local area network (WLAN) before associating with the AP for the purposes of performing pre-association discovery (PAD) through the AP.

The methods may include communicating with a remote information server (IS) by sending messages to a WLAN using an L2 address and receiving responses from the IS through the WLAN. The WTRU may not have associated with the WLAN.

WLANs and methods for use in WLANs for the purpose of performing PAD are disclosed. The methods may include receiving a message including a source IP address from an unassociated wireless transmit and receive unit (WTRU); and restricting the use of the source IP address by the unassociated WTRU.

The methods may include receiving a PAD request from an WTRU; and relaying messages between the WTRU and a remote information server (IS) for PAD information exchange, wherein the WTRU does not have an IP address for use with the WLAN and the WTRU is not associated with the WLAN.

### BRIEF DESCRIPTION OF THE DRAWINGS

A more detailed understanding may be had from the following description, given by way of example in conjunction with the accompanying drawings wherein:

FIG. 1A is a diagram of an example communications system 100 in which one or more disclosed embodiments may be implemented;

FIG. 1B is a system diagram of an example WTRU 102;

FIG. 1C is a system diagram of the RAN 104 and the core network 106 according to an embodiment;

FIG. 2 is a system diagram of an example communication system in which one or more disclosed embodiments may be implemented;

FIG. 3A illustrates an example of a WTRU 102 obtaining an IP address for pre-associating discovery (PAD) according to some disclosed embodiments;

FIG. 3B illustrates an example of a WTRU obtaining an IP address for PAD from the AP 170 according to some disclosed embodiments;

FIG. 3C illustrates an example of a WTRU obtaining an IP address for PAD from the AP according to some disclosed embodiments;

FIG. 4 illustrates an example of a PAD method according to some disclosed embodiments;

FIG. 5 illustrates an example of a PAD method according to some disclosed embodiments;

FIG. 6 illustrates a PAD method according to some disclosed embodiments;

FIG. 7 illustrates a WTRU according to some disclosed embodiments;

FIG. 8A illustrates a method for PAD according to some disclosed embodiments;

FIG. 8B illustrates the PAD session request 804 according to some embodiments;

FIG. 9 illustrates a method of PAD discovery where a PAD session ID is broadcast using a session digest according to some disclosed embodiments;

FIG. 10 illustrates a method for PAD discovery where EAPOL start is used according to some disclosed embodiments;

FIG. 11 illustrates a method according to some disclosed embodiments;

FIG. 12 illustrates a method according to some disclosed embodiments.

FIG. 13 illustrates a bitmap of service categories according to some embodiments; and

FIG. 14 illustrates a method according to some disclosed embodiments.

### DETAILED DESCRIPTION

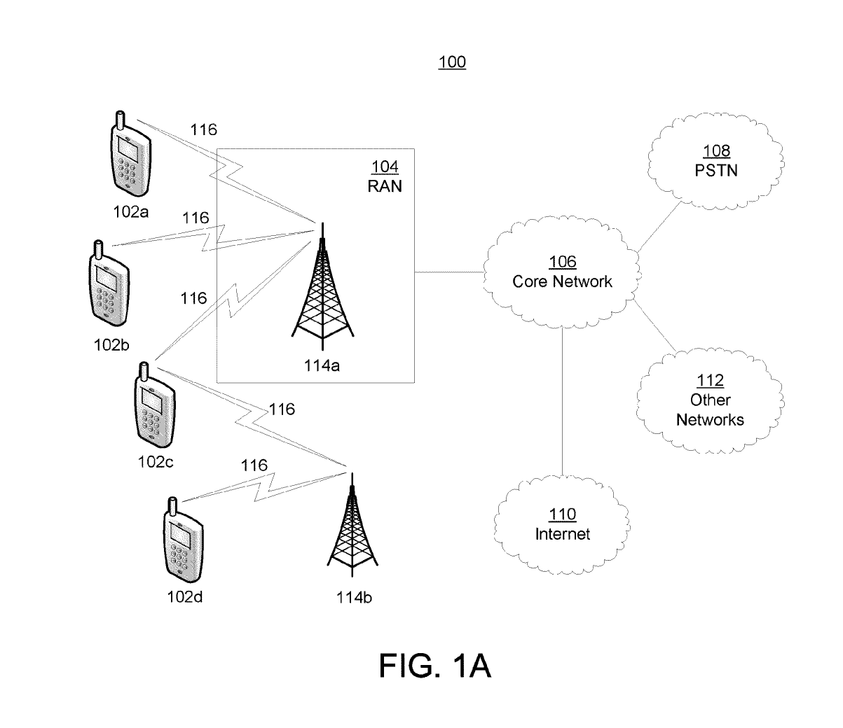

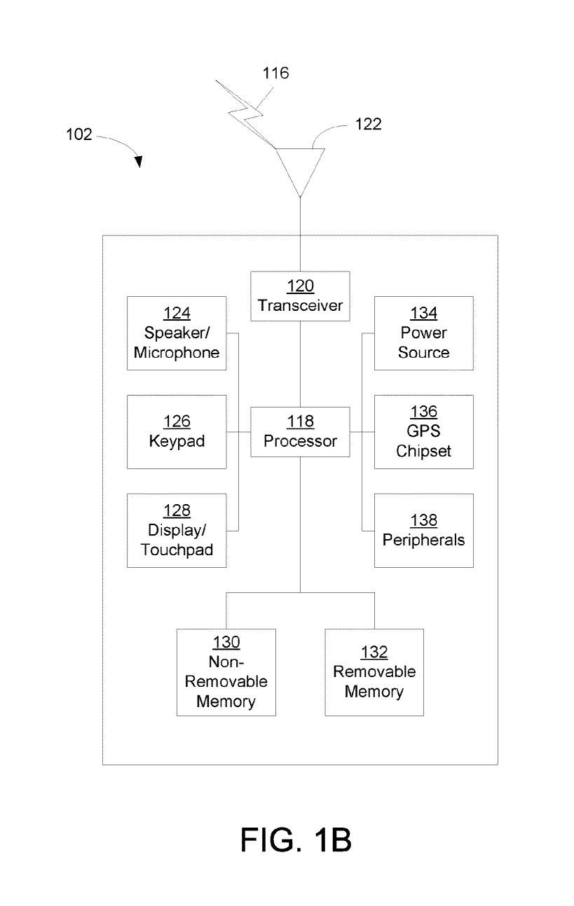

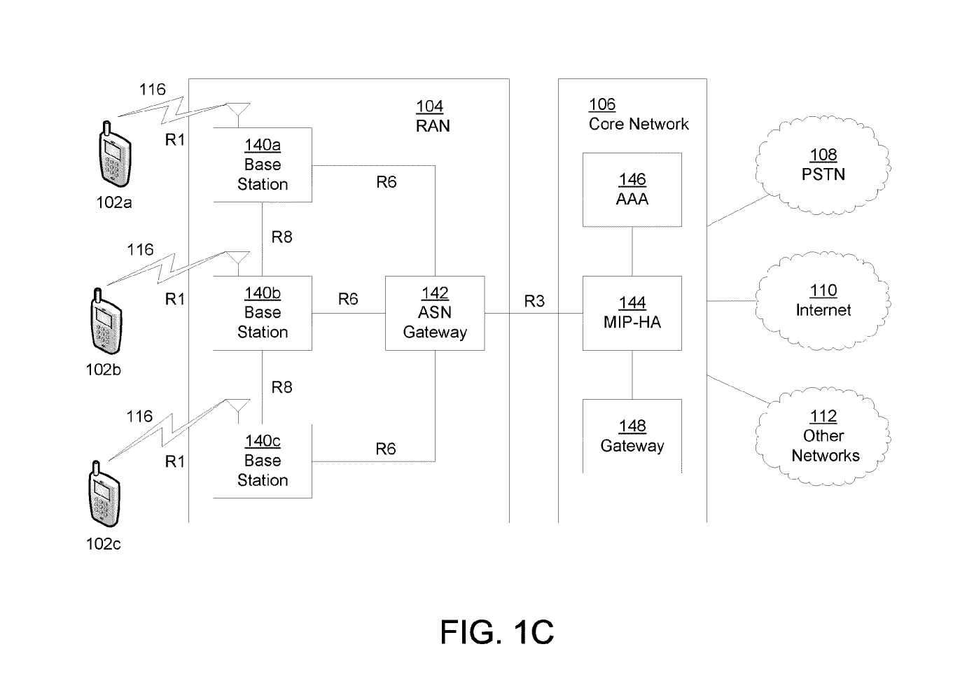

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The other networks 112 may include wired or wireless communications networks owned and/or operated by other service providers. For example, the other networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1C, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 102c.

As shown in FIG. 1C, the RAN 104 may be connected to the core network 106. The communication link between the RAN 104 and the core network 106 may be defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1C, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

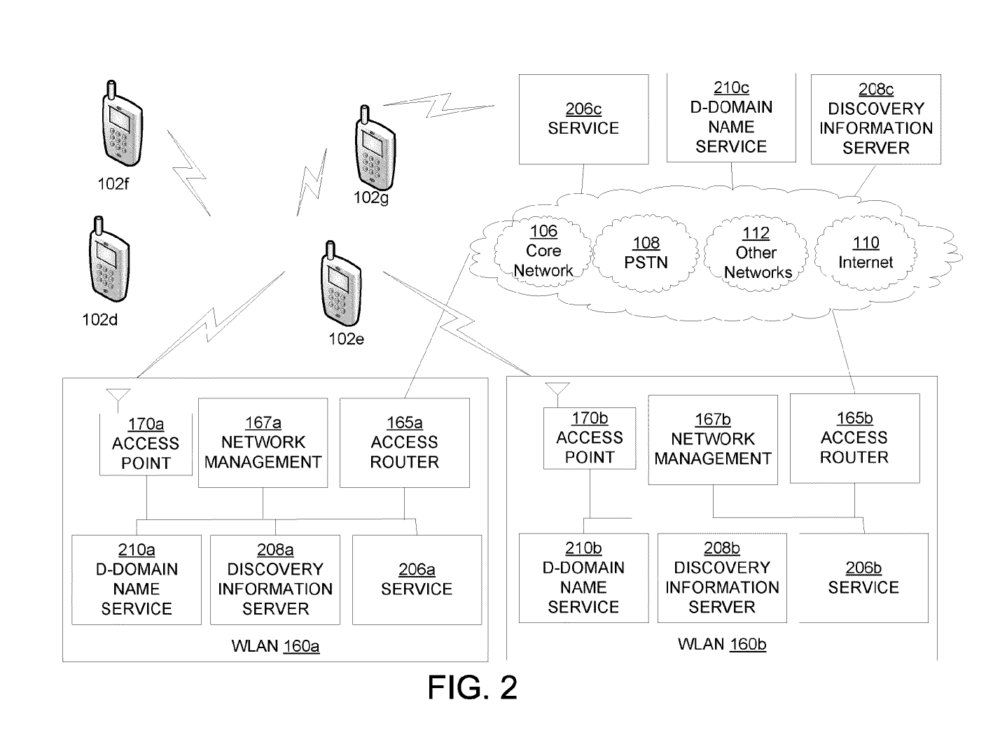

FIG. 2 is a system diagram of an example communication system in which one or more disclosed embodiments may be implemented. Illustrated in FIG. 2 are WTRUs 102d, 102e, 102f,102g, WLANs 160a, 160b, core network 106, PSTN 108, other networks 112, Internet 110, services 206a, 206b, 206c, discovery information servers (DISs) 208a, 208b, 208c, and D-domain name services (D-DNSs) 210a, 210b, 210c. The WLANs 106a, 106b may include access routers 165a, 165b, access points (AP) 170a, 170b, services 206a, 206b, network management 167a, 167b, and discovery information servers (DISs) 208a, 208b. The WLANs 106a, 106b may be 802.11, 802.15, 802.16, or 802.1x networks where the WTRUs 102d, 102e, 102f, 102g, are often referred to as STAs 102d, 102e, 102f, 102g, or UEs 102d, 102e, 102f, 102g. In some embodiments, a STA 102d, 102e, 102f, 102g, is defined by having an address to access the STA 102d, 102e, 102f, 102g. The WLAN 106 may be directly connected to or indirectly connected to one or more of the WTRUs 102d, 102e, 102f, 102g, a core network 106, a PSTN 108, other network 112, and the Internet 110.

The WTRUs 102d, 102e, 102f, 102g, may be considered clients (CL) 102d, 102e, 102f, 102g, to the APs 170a, 170b, in 802.1x. The WTRUs 102d, 102e, 102f, 102g, may not be associated with a WLAN 160a, 160b. The WTRUs 102d, 102e, 102f, 102g, may be associated with one or more of the core network 106, the PSTN 108, other network 112, the Internet 110, service 206c, another WTRU 102d, 102e, 102f, 102g, or the WLANs 106a, 106b. A service 206a, 206b, 206c, may be something provided by the core network 106, the PSTN 108, other network 112, the Internet 110, the WLANs 106, or one or more components of the core network 106, the PSTN 108, other network 112, the Internet 110, or the WLANs 106, for the WTRU 102d, 102e, 102f, 102g. Examples of a service 206a, 206b, 206c, include a high-resolution color printer providing printer services 206a, 206b, 206c, access to the Internet 110 via a WLAN 160a, 160b, access to the Internet 110 with a certain bandwidth, access to VoIP, or access to a core network 106 such as a 3GPP LTE network. Although the service 206a, 206b, 206c, is illustrated as being separate, the service 206a, 206b, 206c, may be integrated with the AP 170a, 170b, access router 165a, 165b, DISs 208a, 208b, 208c, d-domain name service 210a, 210b, or another component of the WLAN 160a, 160b. The service 206a, 206b, 206c, may refer to a component or device of the core network 106, the PSTN 108, other network 112, the Internet 110, or the WLANs 106.

In some embodiments, the AP 170 a, 170b, may be an access point for 802.11, a base station for 802.16, or another transmit and receive device for access to the WLAN 160a, 160b.

The network management 167a, 167b may provide network management 167a, 167b service for the WLAN 160a, 160b. The network management 167a, 167b may be a separate device or may be integrated with another component of the WLAN 160a, 160b. For example, the network management 167a, 167b may be integrated with the AP 170a, 170b, the DIS 208a, 208b, access router 165a, 165b, d-domain name service 210a, 210b, or service 206a, 206b. Additionally, in some embodiments, some of the functionality of the network management 167a, 167b may be split between two or more components of the WLAN 160a, 160b. The network management 167a, 167b may be configured to provide network management services such as NAT services, IP filter services, IP gateway services, etc. In some embodiments, some of the network management 167a, 167b may be performed outside the WLAN 160a, 160b. A DIS 208a, 208b, 208c, may be a server providing service information for one or more services 206a, 206b, 206c. The service information may identify services 206a, 206b, 206c, and may provide access information such as parameters for the WTRUs 102d, 102e, 102f, 102g, to access the service 206a, 206b, 206c. For example, a service 206a, 206b, 206c, may be a 3D printer 206a, 206b, 206c, and the access information may include a cost per printing unit and an IP address for accessing the high-resolution color printer 206a, 206b, 206c. Although the DIS 208a, 208b, 208c, is illustrated as being separate, the DIS 208a, 208b, 208c, may be integrated with the AP 170a, 170b, access router 165a, 165b, DIS 208a, 208b, 208c, or another component. The DIS 208a, 208b, 208c, may be configured to implement a network protocol, which may be called a network discovery protocol or discovery protocol, such as 3GPP access network discovery and selection function (ANDSF,) which provides a service 206a, 206b, 206c, for a WTRU 102d, 102e, 102f, 102g, to identify which WLANs 160a, 160b, a 3GPP provider would like the WTRU 102d, 102e, 102f, 102g, to use to access the Internet 110. The DIS 208a, 208b, 208c, may be configured to implement other network protocols such as EAP, Bonjour®, ANQP, etc. The DIS 208a, 208b, 208c, may be configured to implement link layer protocols such as GAS. The DIS 208a, 208b, 208c, may be located within a WLAN 160a, 160b, a 3GPP network, or another network. In some embodiments, the DIS 208a, 208b, 208c, has a static IP address. In some embodiments, the DIS 208a, 208b, 208c, has a non-static IP address. In some embodiments, the DIS 208a, 208b, 208c, may be called an advertisement server. In some embodiments, accessing the DIS 208a, 208b, 208c, may be called a local access when the WTRU 102d, 102e, 102f, 102g, is in the same WLAN 160a, 160b, as the DIS 208a, 208b, 208c. For example, the WTRU 102e may locally access the DIS 208a, if the WTRU 102e access the DIS 208a via AP 170a. In some embodiments, accessing the DIS 208a, 208b, 208c, may be called a remote access when the WTRU 102d, 102e, 102f, 102g, is in a different WLAN 160a, 160b, as the DIS 208a, 208b, 208c. For example, when the WTRU 102e is using AP 170a to access DIS 208b or DIS 208c, then the WTRU 102e is remotely accessing DIS 208b or DIS 208c.

In some embodiments, the DIS 208a, 208b, 208c, permits an open access to a WTRU 102d, 102e, 102f, 102g, that queries the DIS 208a, 208b, 208c. For example, the DIS 208a, 208b, 208c, may advertise printing services and other hotel services available to guests. In some embodiment, Bonjour® is open access.

In some embodiments, the DIS 208a, 208b, 208c, requires direct authentication. The DIS 208a, 208b, 208c, may require the WTRU 102d, 102e, 102f, 102g, to authenticate to DIS 208a, 208b, 208c, in order to access the DIS 208a, 208b, 208c. In some embodiments, the WTRU 102d, 102e, 102f, 102g, may require the DIS 208a, 208b, 208c, to authenticate with the WTRU 102d, 102e, 102f, 102g. Examples include a DIS 208a, 208b, 208c, that is a cloud service providers or mobile virtual network operator (MVNO). The DIS 208a, 208b, 208c, that is an MVNO may not want to advertise which networks it has agreements with to anyone but its customers, which would require the customer to authenticate with the DIS 208a, 208b, 208c, that is a MVNO before the DIS 208a, 208b, 208c, that is a MVNO discloses information to the WTRU 102d, 102e, 102f, 102g, of the customer.

In some embodiments, the DIS 208a, 208b, 208c, access permission may be bootstrapped from another set of credentials. For example, in a DIS 208a, 208b, 208c, that is an ANDSF the access to the DIS 208a, 208b, 208c, that is an ANDSF may be bootstrapped from the 3GPP network authorization of the WTRU 102d, 102e, 102f, 102g.

In some embodiments, the DIS 208a, 208b, 208c, may perform discovery to obtain information regarding services 206a, 206b, 206c. In some embodiments, the DIS 208a, 208b, 208c, may discover information regarding local peer-to-peer devices (LPP) and provide the information to WTRUs 102d, 102e, 102f, 102g. For example, the DIS 208a may discover information regarding service 206a. The DIS 208a, 208b, 208c, may be located locally with a service 206a, and the service 206a, which may be a peer device, may want to advertise its service capabilities.

Proximity to the users (not illustrated) of the WTRU 102d, 102e, 102f, 102g, who may want to use the service 206a, 206b, 206c, may be an important aspect of discovery of services 206a, 206b, 206c, and so whether or not a service 206a, 206b, 206c, is local to the WTRU 102d, 102e, 102f, 102g, may be important. Additionally, physical proximity between the WTRU 102d, 102e, 102f, 102g, and the service 206a, 206b, 206c, may be important. For example, the service 206a, 206b, 206c, may be a network printer, which may also be a DIS 208a, 208b, 208c, that advertises it location and accessibility via a WLAN 160a, 160b, as well as the details of the services 206a, 206b, 206c, it can provide. For example, the service 206a, 206b, 206c, that is a network printer may advertise that it is a laser printer with photograph quality prints available at a particular price per print.

In some embodiments, the DIS 208a, 208b, 208c, may use a Bonjour-based peer discovery to obtain information about services 206a, 206b, 206c. In some embodiments, the DIS 208a, 208b, 208c, may discovery proximate WTRUs 102d, 102e, 102f, 102g, that are part of a social network circle. In some embodiments, the DIS 208a, 208b, 208c, may discover proximate WTRUs 102d, 102e, 102f, 102g, that are part of the same service 206a, 206b, 206c, such as interactive game. The DIS 208a, 208b, 208c, may use this information to set up an optimized connection for the WTRUs 102d, 102e, 102f, 102g, that are using the service 206a, 206b, 206c that is an interactive game.

In some embodiments, the WTRU 102d, 102e, 102f, 102g, seeks to discover the IP address of the DIS 208a, 208b, 208c, so that the WTRU 102d, 102e, 102f, 102g, can query the DIS 208a, 208b, 208c, for discovery information.

In some embodiments, the WTRU 102d, 102e, 102f, 102g, may want to discover information regarding a service 206a, 206b, 206c that is a remote peer-to-peer (RPP) communications service. The service 206a, 206b, 206c, or peer may be remote to the WTRU 102d, 102e, 102f, 102g. A service 206a, 206b, 206c, or peer may be considered remote to the WTRU 102d, 102e, 102f, 102g, if the service 206a, 206b, 206c, or peer is on a different network than the WTRU 102d, 102e, 102f, 102g, so that link-local IP addresses may not work for the WTRU 102d, 102e, 102f, 102g, to communicate with the service 206a, 206b, 206c, or peer that is remote. For example, if WTRU 102e is communicating via AP 170a, then service 206b and service 206c may be services 206b, 206c that are remote, since in order to access service 206b or service 206c an access router 165a, 165b, is between the services 206b, 206c and the WTRU 102e.

In some embodiments, the WTRU 102d, 102e, 102f, 102g, may want to discover information regarding local server-based discovery (LSD). This use case category captures those use cases where the DIS 208a, 208b, 208c, is located in the same network as the AP 170a, 170b, the WTRU 102d, 102e, 102f, 102g, is using for communications. For example, it can be functionally considered to be co-located with the AP 170a, 170b, or it is on the same network; thus, for example, link-local addressing IP addressing is sufficient for the WTRU 102d, 102e, 102f, 102g, or the service 206a, 206b, 206c, to communicate with the DIS 208a, 208b, 208c.

In some embodiments, the WTRU 102d, 102e, 102f, 102g, may not be directly interested in the IP address of the DIS 208a, 208b, 208c, for LSD. In some embodiments, the DIS 208a, 208b, 208c, may be used to provide some other information which will be used by the WTRU 102d, 102e, 102f, 102g. In some embodiments, the DIS 208a, 208b, 208c, may be a centralized database of available printers, a database of all services which a hotel provides to its guests, a WLAN 160a, 160b, hotspot's subscription information server accessed via ANQP, a localized mirror of a macro-network information service, such as ANDSF, or a WLAN 160a, 160b, advertising which services can be accessed through this WLAN 160a, 160b, which may include costs.

Some WLANs 160a, 160b, support a service 206a, 206b, 206c, that is peer-to-peer by providing means for devices or service providers to register services 206a, 206b, 206c, that they support with a DIS 208a, 208b, 208c. Service 206a, 206b, 206c, registration may be performed by the services 206a, 206b, 206c, which may be devices, with the DIS 208a, 208b, 208c.

In some embodiments, the WTRU 102d, 102e, 102f, 102g, may want to discover information regarding a DIS 208a, 208b, 208c, that is remote. When the WTRU 102d, 102e, 102f, 102g, performs discovery accessing a DIS 280 that is a remote, the WTRU 102d, 102e, 102f, 102g, may be performing remote server-based discovery (RSD). The DIS 208a, 208b, 208c, may be called remote, when the DIS 208a, 208b, 208c, is not part of the AP 170a, 170b that the WTRU 102d, 102e, 102f, 102g, is communicating with. The location, which may be an IP address, of a DIS 208a, 208b, 208c, that is remote may be used by the WTRU 102d, 102e, 102f, 102g, to access information that may be provided by the DIS 208a, 208b, 208c. In some embodiments, a DIS 208a, 208b, 208c, that is remote to the WTRU 102d, 102e, 102f, 102g, may not be accessible to the WTRU 102d, 102e, 102f, 102g, by using local access means. Moreover, a DIS 208a, 208b, 208c, that is remote may not include information about services 206a, 206b, 206c, that are local to the DIS 208a, 208b, 208c. Some examples include a DIS 208a, 208b, 208c, that is a MVNO database listing access networks which can be used for MVNO-based access; a DIS 208a, 208b, 208c, that is a cloud-service provider listing access networks with which it has contracted for its customers to access its services; and, a DIS 208a, 208b, 208c, that is a service provider, for example, a mobile operator or a content provider database listing hotspots, which can be used to access the service 206a, 206b, 206c. Another example of a DIS 208a, 208b, 208c, is a DIS 208a, 208b, 208c, that is a RSD ANDSF, which may be accessed by a WTRU 102d, 102e, 102f, 102g, through a non-3GPP access network such as WLAN 160a, 160b, via the Internet 110 or another network.

One or more of the APs 170a, 170b, may be configured to implement a network protocol such as Access Network Query Protocol (ANAQ), which is a standard for 802.11 specified in 802.11u. The APs 170a, 170b, and the WTRUs 102d, 102e, 102f, 102g, may be configured to implement generic advertising services (GAS) protocol, which may be implemented in 802.1x networks.

One or more of the components of the WLANs 160a, 160b, may be configured to implement a network protocol such as zeroconf, or a deriviative implementation of zeroconf such as Bonjour®, which may be used to discover services 206a, 206b, 206c.

In some embodiments, the AP 170a, 170b, or another component of the WLAN 160a, 160b, may be configured to implement a network address translation (NAT). Portions of the functionality of the AP 170a, 170b, may be provided by another node or host of the WLAN 160a, 160b, or another network, where the AP 170a, 170b, provides access.

The D-DNSs 210a, 210b, 210c, may be configured to return an IP address for a given name. In some embodiments, the D-DNSs 210a, 210b, 210c, may be configured to restrict the IP addresses returned to the WTRU 102d, 102e, 102f, 102g. The D-DNSs 210a, 210b, 210c, may be configured to restrict the IP addresses returned to the WTRU 102d, 102e, 102f, 102g, when the WTRU 102d, 102e, 102f, 102g, has not associated with the AP 170a, 170b.

Throughout the discussion that follows a WTRU 102d, 102e, 102f, 102g, may refer to the WTRU 102d, 102e, 102f, 102g, the WTRU 102d, 102e, 102f, 102g, and the user of the WTRU 102d, 102e, 102f, 102g, or the user of the WTRU 102d, 102e, 102f, 102g. The WTRU 102d, 102e, 102f, 102g, may want to use a service 106, but would like to find out whether or not a WLAN 160a, 160b, provides the service 106 before associating with the WLAN 160a, 160b. In some embodiments, for a WTRU 102d, 102e, 102f, 102g, to associate with a WLAN 160a, 160b, the WTRU 102d, 102e, 102f, 102g, and the WLAN 160a, 160b, perform a multi-step process that may require the WTRU 102d, 102e, 102f, 102g, to provide payment information in order to associate with the WLAN 160a, 160b.

Additionally, there may be many WLANs 160a, 160b, available, and it may be impractical to associate with each WLAN 160a, 160b, and then evaluate whether or not the WLAN 160a, 160b, is a good fit for the WTRU 102d, 102e, 102f, 102g, based on the one or more services 206a, 206b, 206c, the WTRU 102d, 102e, 102f, 102g, may want to use. In some embodiments, the WTRU 102d, 102e, 102f, 102g, may not have an Internet protocol (IP) address for a WLAN 160a, 160b, prior to associating with the WLAN 160a, 160b.

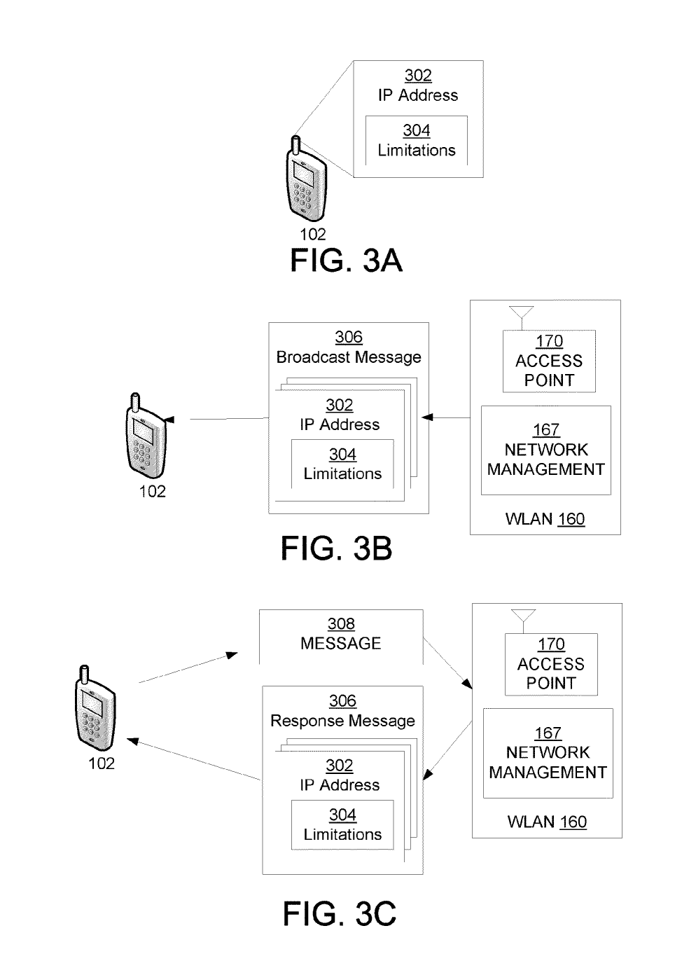

FIG. 3A illustrates an example of a WTRU 102d, 102e, 102f, 102g, obtaining an IP address for pre-associating discovery (PAD) according to some disclosed embodiments. In some embodiments, the WTRU 102d, 102e, 102f, 102g, may randomly select an IP address 302. In some embodiments, a set or space of IP addresses 302 may be allocated for PAD purposes. In some embodiments, the WTRU 102d, 102e, 102f, 102g, may randomly select an IP address from the space of IP addresses allocated for PAD purposes. In some embodiments, the WTRU 102d, 102e, 102f, 102g, may select the IP address based on some criteria that may be based on a location of the WTRU 102d, 102e, 102f, 102g, a current time, an 802.11 physical address, an Ethernet address, or another number associated with the AP 170a, 170b, WLAN 160a, 160b, or the WTRU 102d, 102e, 102f, 102g, which may be used by the WTRU 102d, 102e, 102f, 102g, to reduce the likelihood of selecting an IP address that is already taken from the space of IP addresses. The space of available IP addresses 302 may be predefined. In some embodiments, the IP address 302 may be limited in use. Examples of the limitations 304 include a lifetime or an amount of time the IP address 302 can be used before expiring, and a number of packets that may be sent using the IP address 302 before the IP address expires. Other limitations 304 of the IP address 302 may be used. In some embodiments, the limitations 304 may be predefined. In some embodiments, the WTRU 102d, 102e, 102f, 102g, may receive the limitations 304.

FIG. 3B illustrates an example of a WTRU obtaining an IP address for PAD from the WLAN 160a, 160b, according to some disclosed embodiments. In some embodiments, the AP 170a, 170b, may send one or more IP addresses 302 in a broadcast message 306. The network management 167a, 167b may determine the IP addresses 302 for the AP 170a, 170b, to send in the broadcast message 306. In some embodiments, the AP 170a, 170b, and the network management 167a, 167b are integrated into the same device. The WTRU 102d, 102e, 102f, 102g, may select an IP address 302 from the broadcast message 306 to use for PAD. In some embodiments, the IP address 302 may be limited in use. In some embodiments, the limitations 304 may be sent to the WTRU 102d, 102e, 102f, 102g, from the AP 170a, 170b, and may be determined by the network management 167a, 167b. In some embodiments, the broadcast message 306 may be part of the service digest broadcast.

FIG. 3C illustrates an example of a WTRU obtaining an IP address for PAD from the WLAN 160a, 160b, according to some disclosed embodiments. The WTRU 102d, 102e, 102f, 102g, sends a message 308 to the WLAN 160a, 160b, via the AP 170a, 170b, and the WLAN 160a, 160b, responds with one or more IP addresses 302 in a response message 310 via the AP 170a, 170b. The network management 167a, 167b may determine the one or more IP addresses 302. The message 308 may be part of an L2 discovery method. The message 308 may be a direct L2 PAD query. There may be more messages (not illustrated) exchanged between the WTRU 102d, 102e, 102f, 102g, and the WLAN 160a, 160b, for the WTRU 102d, 102e, 102f, 102g, to obtain the one or more IP addresses 302. Additionally, the message 308 may be in response to a message (not illustrated) received by the WTRU 102d, 102e, 102f, 102g, from the WLAN 16a, 16b, that indicates that the WTRU 102d, 102e, 102f, 102g, may receive an IP address 302 from the WLAN 160a, 160b.

In some embodiments, if multiple WTRUs 102d, 102e, 102f, 102g, use the same IP address 302, the WLAN 160a, 160b, may be configured to reject one or more of the WTRUs 102d, 102e, 102f, 102g, that are using the same IP address 302. In some embodiments, the WLAN 160a, 160b, may be configured to cease broadcasting an IP address 302 if the IP address 302 is being used by a WTRU 102d, 102e, 102f, 102g. In some embodiments, if the WTRU 102d, 102e, 102f, 102g, session request using the IP address 302 is rejected, the WTRU 102d, 102e, 102f, 102g, may obtain another IP address 302 according to one of the embodiments disclosed and attempt a new session with the WLAN 160a, 160b. In some embodiments, the WTRU 102d, 102e, 102f, 102g, may wait or back off a period of time before attempting to associate with the WLAN 160a, 160b, after having a session request being rejected. The WTRU 102d, 102e, 102f, 102g, may wait a period of time that increases with the number of times the WTRU 102d, 102e, 102f, 102g, has been rejected.

In some embodiments, the WLAN 160a, 160b, may control the amount of PAD traffic by controlling the number of IP addresses it broadcasts and may discontinue all PAD traffic by discontinuing broadcasting IP addresses 302.

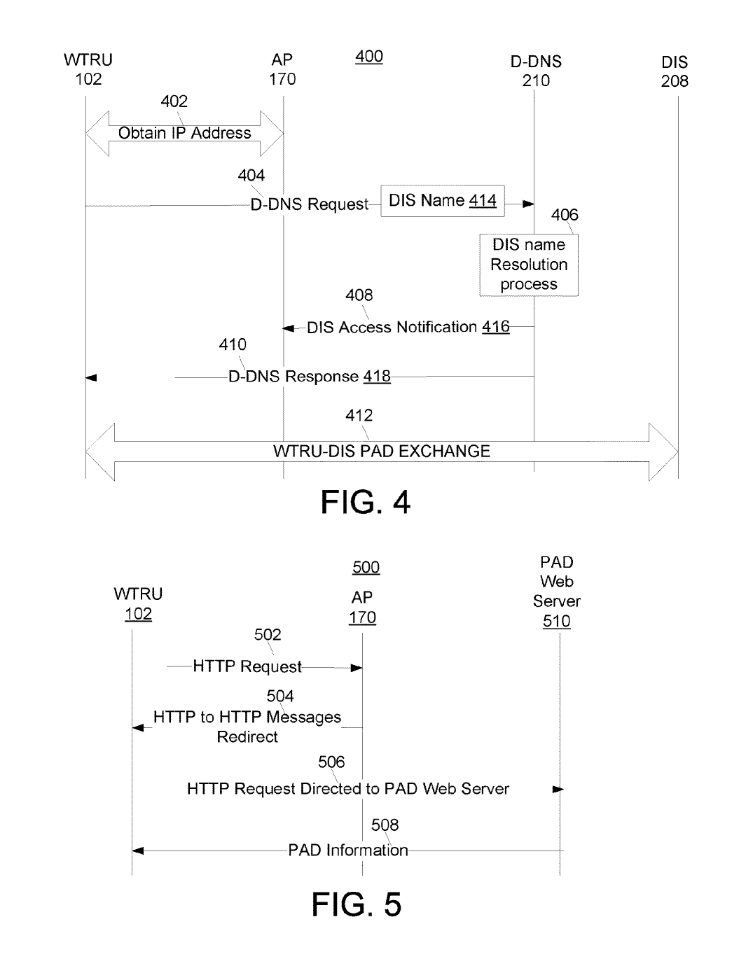

FIG. 4 illustrates an example of a PAD method according to some disclosed embodiments. The method 400 may begin with obtain IP address 402. The WTRU 102d, 102e, 102f, 102g, may obtain an IP address 302 according to one of the methods described in association with FIG. 3. The WTRU 102d, 102e, 102f, 102g, may bind the IP address 402 with an 802.1x interface. The WTRU 102d, 102e, 102f, 102g, may obtain a session ID (not illustrated) from the AP 170a, 170b, or network management 167a, 167b. For example, the WLAN 160a, 160b may determine the session ID using the network management 167a, 167b, which may be integrated with the AP 170a, 170b, and send the session ID to the WTRU 120e, 102f, 102g via the AP 170a, AP 170b.

The method 400 may continue with the WTRU 102d, 102e, 102f, 102g, sending a D-DNS request 404, which may include a DIS name 406, to the D-DNS 210a, 210b, 210c. The DIS name 406 may be a DIS name 406 that is predetermined. In some embodiments, the request must include the DIS name 406 and session ID.

In some embodiments, the AP 170a, 170b, restricts all communication for the IP address 302, except for communication with a D-DNS 210a, 210b, 210c, that is local. A D-DNS 210a, 210b, 210c, may be considered local if the D-DNS 210a, 210b, 210c, is co-located with the AP 170a, 170b, or part of the same private network, which may be a WLAN 160a, 160b. For example, the AP 170a may restrict all communications with the WTRU 102e to communications with the D-DNS 210a. The IP address of the D-DNS 210a may be provided to the WTRU 102d, 102e, 102f, 102g, by the network management 167a, 167b, via the AP 170a, 170b. For example, AP 170a, 170b, or network management 167a, 167b may provide the IP address of the D-DNS 210a, 210b, 210c, as part of an initial L2 PAD procedure, which may be broadcast or query based. In some embodiments, the WTRU 102d, 102e, 102f, 102g, determines the IP address of the D-DNS 210a, 210b, 210c, in another way such as an agreed upon address for purposes of PAD.

The method 400 may continue with a DIS name resolution process 406. In some embodiments, the D-DNS 210a, 210b, 210c, performs the requested lookup to determine an IP address of the DIS 208a, 208b, 208c. In some embodiments, the D-DNS 210a, 210b, 210c, may act as a DNS Proxy, or a proprietary name resolution server for the purpose of resolving the IP address of the DIS 208a, 208b, 208c. In some embodiments, the D-DNS 210a, 210b, 210c, may maintain a local list of IP addresses of DISs 208a, 208b, 208c, for some or all of supported DISs 208a, 208b, 208c. In some embodiments, the D-DNS 210a, 210b, 210c, may be configured to check the DIS name 414 with a list of allowed DISs 208a, 208b, 208c, which the WTRU 102d, 102e, 102f, 102g, is permitted to access. In some embodiments, if the DIS name 414 is not allowed, the D-DNS 210a, 210b, 210c, returns an error to the WTRU 102d, 102e, 102f, 102g. The error may terminate the PAD procedure, which may make the session ID invalid. The D-DNS 210a, 210b, 210c, may notify the network management 167a, 167b, or the AP 170a, 170b, that the WTRU 102d, 102e, 102f, 102g, attempted to use a DIS name 414 that the WTRU 102d, 102e, 102f, 102g, is not permitted to access, which may result in the network management 167a, 167b, or AP 170a, 170b, terminating the PAD procedure with the WTRU 102d, 102e, 102f, 102g. The network management 167a, 167b, or AP 170a, 170b, for example, may make the IP address 302 invalid or return the IP address to a pool of available IP addresses 302.

The method 400 may continue with the D-DNS sending a DIS access notification to the AP 408. For example, the D-DNS 210a, 210b, 210c, may be configured to notify the AP 170a, 170b, of the resolution of a DIS name 414, where the resolution may be an IP address of the DIS 208a, 208b, 208c. The network management 167a, 167b, or AP 170a, 170b, may be configured to associate the IP address 302 of the WTRU 102d, 102e, 102f, 102g, with the IP address of the DIS 208a, 208b, 208c. The AP 170a, 170b, may then allow the WTRU 102d, 102e, 102f, 102g, to communicate with the IP address of the DIS 208a, 208b, 208c. The D-DNS 210a, 210b, 210c, may provide additional information regarding the DIS 208a, 208b, 208c, to the network management 167a, 167b, or AP 170a, 170b. For example, the D-DNS 210a, 210b, 210c, may include details of an application using PAD and/or protocol signatures for discovery on the DIS 208a, 208b, 208c. The network management 167a, 167b, or AP 170a, 170b, may be configured to load the signatures into a firewall of the WLAN 160a, 160b, or AP 170a, 170b, so as to immediately activate L7-based blocking without the need to perform DPI. In some embodiments, the network management 167a, 167b, or AP 170a, 170b, may respond to the D-DNS 210a, 210b, 210c, by requesting to have the WTRU 102d, 102e, 102f, 102g, use a different IP address for the rest of the PAD session (not shown in FIG. 4).

The method 400 may continue with the D-DNS sending a response to the WTRU 410. For example, the D-DNS response 418 may include the IP address of the DIS 208a, 208b, 208c, based on the DIS name 414. Additional information may be included in the D-DNS response 418. For example, the D-DNS response 418 may include a new IP address for the WTRU 410 to use to switch to or use to communicate with the DIS 208a, 208b, 208c.

The method 400 may continue with WTRU-IS PAD exchange 412. For example, a protocol specific WTRU 102d, 102e, 102f, 102g, and DIS 208a, 208b, 208c, session may proceed where PAD information may be sent to the WTRU 102d, 102e, 102f, 102g, from the DIS 208a, 208b, 208c. In some embodiments, the network management 167a, 167b, or AP 170a, 170b, is configured to allow this session to go ahead based on knowing the IP address of the DIS 208a, 208b, 208c, and the IP address of the WTRU 102d, 102e, 102f, 102g.

In some embodiments, the use of a DNS-based approach can be combined with a local IP for those cases when the D-DNS is local to the network. The D-DNS IP address advertised is a link local address. The address gets replaced by a non-link-local IP for the rest of the PAD procedure. The use of a link-local address minimizes impact to applications on the WTRU 102d, 102e, 102f, 102g, with background services that may wake up based on an IP session.

In some embodiments, the D-DNS 210a, 210b, 210c, may need to be up-to-date to include an entry for the DIS 208a, 208b, 208c. In some embodiments, the AP 170a, 170b, illustrated in FIG. 4 may be a peer to the WTRU 102d, 102e, 102f, 102g. In some embodiments, the method 400 of FIG. 4 may be used for local and remote server based discovery. In some embodiment, the method 400 of FIG. 4 may not be used for remote peer to peer discovery.

FIG. 5 illustrates an example of a PAD method according to some disclosed embodiments. Illustrated in FIG. 5 is a captive portal where the AP 170a, 170b, captures messages from the WTRU 102d, 102e, 102f, 102g, and sends then to the PAD web server 510.

The AP 170a, 170b, illustrated in FIG. 5 may refer to both the network management 167a, 167b of the WLAN 160a, 160b, and to the transmit and receive functionality of the AP 170a, 170b. For example, the network management 167a, 167b, may be configured to intercept and interpret higher layer packets such as IP and HTTP. The network management 167a, 167b, or portions of the network management 167a, 167b, may be incorporated into the AP 170a, 170b; or, the AP 170a, 170b, may forward the messages to the network management 167a, 167b, which then sends messages back to the AP 170a, 170b.

The method 500 may begin with the WTRU 102d, 102e, 102f, 102g, sending an HTTP request to the AP 170a, 170b, at 502. The WTRU 102d, 102e, 102f, 102g, is in a pre-authorization or pre-association state relative to the AP 170a, 170b. The method 500 continues with HTTP to HTTP messages redirect 504. The AP 170a, 170b, may be configured to intercept all messages from the WTRU 102d, 102e, 102f, 102g, regardless of address until the WTRU 102d, 102e, 102f, 102g, which may be in a PAD state, sends browser messages and tries to access the Internet 110 using HTTP. The AP 170a, 170b, may be configured to intercept all packets with HTTP status code three hundred and two (“302”) and include information of the address of the PAD web server 510 in the packet.

The method 500 may continue with HTTP request directed to PAD web server 506. The AP 170a, 170b, may receive HTTP packets from the WTRU 102d, 102e, 102f, 102g, and re-direct the packets to the PAD web server 510.

The method 500 may continue with PAD information 508. The WTRU 102d, 102e, 102f, 102g, may receive PAD information from the PAD web server 510. The communication between the WTRU 102d, 102e, 102f, 102g, and PAD web server 510 may continue with steps 506 and 508 being repeated one or more times.

In some embodiments, the initial HTTP request may be made by the WTRU 102d, 102e, 102f, 102g, prior to the authentication with the AP 170a, 170b, and may be made transparently to the user of the WTRU 102d, 102e, 102f, 102g. In some embodiments, a dedicated domain name may be used to access the PAD web server 510. The dedicated domain name could be a new DNS name, which may not necessarily be human readable but machine comprehensive. In some embodiments, a new Special Domain Name Extension for PAD purpose, such as “.pad” may be reserved for PAD use.

In some embodiments, the method 500 is used for local and remote peer-to-peer discovery. In some embodiment, the method 500 is used for local and remote peer-to-server discovery.

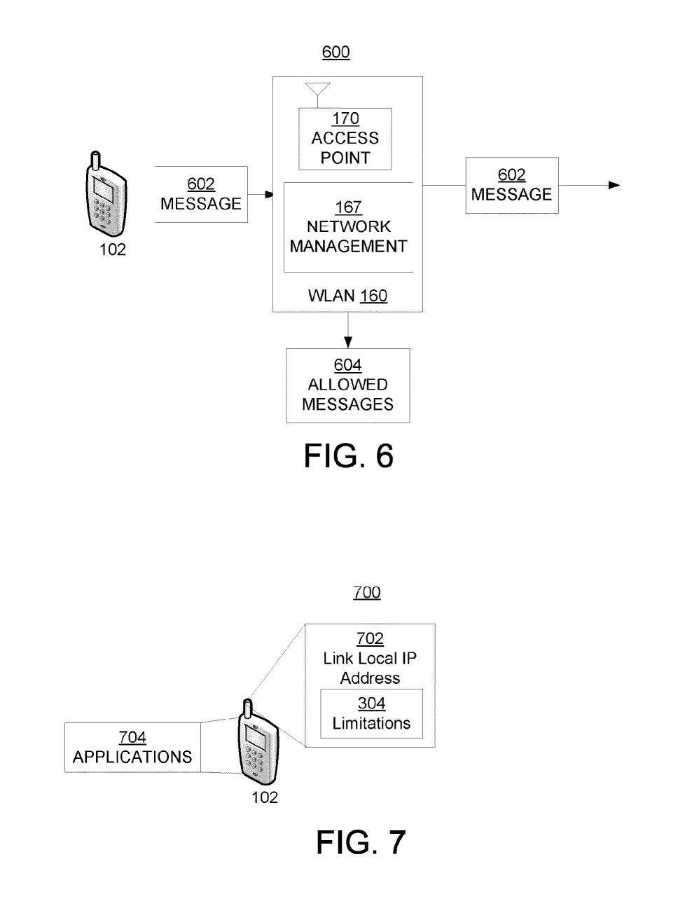

FIG. 6 illustrates a PAD method according to some disclosed embodiments. The AP 170a, 170b, illustrated in FIG. 6 may refer to both the network management 167a, 167b of the WLAN 160a, 160b, and to the transmit and receive functionality of the AP 170a, 170b. For example, the network management 167a, 167b, may be configured to intercept and interpret higher layer packets such as IP and HTTP. The network management 167a, 167b, or portions of the network management 167a, 167b, may be incorporated into the AP 170a, 170b; or, the AP 170a, 170b, may forward the messages to the network management 167a, 167b, which then sends messages back to the AP 170a, 170b.

The WTRU 102d, 102e, 102f, 102g, may send a message 602. The AP 170a, 170b, may be configured to examine the message 602 using allowed messages 604. The AP 170a, 170b, may be configured to only permit messages 602 that fit the criteria in allowed message 604 to be forwarded through the AP 170a, 170b. The allowed messages 604 may include a list of IP addresses of DISs 208a, 208b, 208c. Allowed messages 604 may also include information relating to the transport protocol and port, and application signature so that the WTRU 102d, 102e, 102f, 102g, may only communicate according to the information in allowed messages 604. The AP 170a, 170b, may be configured to block all messages 602 unless the <IS IP address, application signature> pair are permitted in allowed messages 604. In some embodiments, determining whether or not a message 602 conforms with allowed messages 604 may be computationally expensive. In some embodiments, the identification of application signatures by examining the port numbers may be unreliable since the WTRU 102d, 102e, 102f, 102g, and the DIS 208a, 208b, 208c, may agree to use TCP port 80 for non-HTTP applications that are not service discovery, and many PAD applications are higher-layer protocols running on HTTP so that port based inspection cannot distinguish the difference between the use of a legitimate service discovery protocol and normal web browsing. Additionally, DPI-based application identification often takes time, and during this time some traffic may be permitted to go through. This traffic may be short non-PAD sessions to get around the AP 170a, 170b, screening the messages 602. In some embodiments, methods are used to quickly determine whether or not a message 602 is an allowed message 604.

FIG. 7 illustrates a WTRU according to some disclosed embodiments. In some embodiments, a link-local IP address 702 may be used by the WTRU 102d, 102e, 102f, 102g. Link local IP addresses 702 are sufficient for communication with devices on the same L2 network. For example, a link local IP address for WLAN 160a (FIG. 2) would be sufficient to address all the node or hosts in the WLAN 160a.

The method may be used for link-local IP address 702. For example, an IPv6 messages may be used. The method proceeds as follows, because it occurs over a direct L2, all communication may be direct between the WTRU 102d, 102e, 102f, 102g, and the DIS 208a, 208b, 208c. The WTRU 102d, 102e, 102f, 102g, may solicit PAD information by issuing an IPv6 router solicitation message ICMPv6 Type 133. In some embodiments, a new code for PAD advertisement may be used. Options field may be used to list specific services the WTRU 102d, 102e, 102f, 102g, wishes to discover. In some embodiments, the WTRU 102d, 102e, 102f, 102g, and the DIS 208a, 208b, 208c, have agreed on binary designations for service codes. In some embodiments, the DIS 208a, 208b, 208c, issues an ICMP router advertisement (RA) message ICMPv6 Type 134. A new code may be used for PAD advertisements. The PAD RA may be broadcast at scheduled intervals and/or may be sent in response to a specific RS. The WTRU 102d, 102e, 102f, 102g, may use the PAD RA issues by DIS 208a, 208b, 208c, to proceed with a higher layer PAD procedure. If specific information about supported services was transmitted in the options field, it may be used by the WTRU 102d, 102e, 102f, 102g, to decide whether or not to proceed with this step. Other ICMPv6 messages may be used in a similar fashion. For example, neighbor solicitation/advertisement ICMPv6 Types 135/136 may be modified in a similar way or PAD specific ICMP messages may be introduced. In some embodiments, IPv4 RS/RA messages may be used.

In some embodiments, using link-local IP addresses 702 enables the WTRU 102d, 102e, 102f, 102g, to communicate with local peers and servers, but may not permit the WTRU 102d, 102e, 102f, 102g, to communicate directly with remote peers or servers. In some embodiments, the WTRU 102d, 102e, 102f, 102g, may communicate with an AP using link-local IP address 702 so as not to wake up applications 704. In some embodiments, the AP transparently rely messages between the WTRU 102d, 102e, 102f, 102g, and the DIS by using a non-link local IP address to communicate with the DIS, and a link local IP address to communicate with the WTRU 102d, 102e, 102f, 102g. In some embodiments, the AP will monitor the messages sent by the WTRU 102d, 102e, 102f, 102g, with the allowed messages 604, and if a message is sent that is not an allowed message 604 the AP may take action. Some examples of the actions the AP may take include invalidating the WTRU 102d, 102e, 102f, 102g, session ID, dropping the message, and sending a warning to the WTRU 102d, 102e, 102f, 102g.

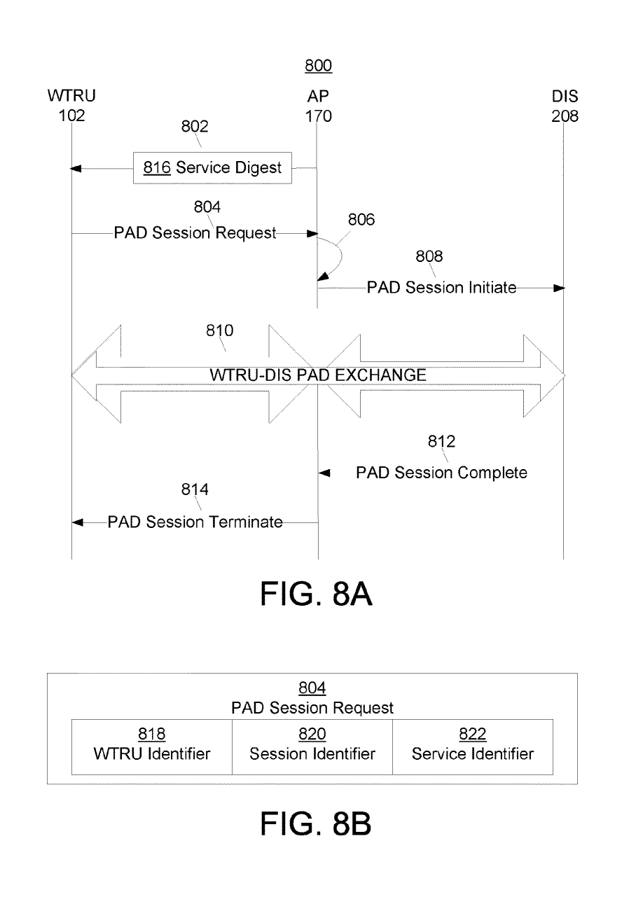

FIG. 8A illustrates a method for PAD according to some disclosed embodiments. The AP 170a, 170b, illustrated in FIG. 8 may refer to both the network management 167a, 167b of the WLAN 160a, 160b, and to the transmit and receive functionality of the AP 170a, 170b. For example, the network management 167a, 167b, may be configured to intercept and interpret higher layer packets such as IP and HTTP. The network management 167a, 167b, or portions of the network management 167a, 167b, may be incorporated into the AP 170a, 170b; or, the AP 170a, 170b, may forward the messages to the network management 167a, 167b, which then sends messages back to the AP 170a, 170b.

The method 800 may optionally begin with the AP 170a, 170b, sending a service digest 802 to the WTRU 102d, 102e, 102f, 102g. The service digest 802 may be a broadcast message sent by the AP 170a, 170b. The service digest 802 may include a summary of the available services 206a, 206b, 206c. The WTRU 102d, 102e, 102f, 102g, may be configured to examine the service digest 802 and determine whether or not the service 206a, 206b, 206c, the WTRU 102d, 102e, 102f, 102g, is looking for may be present through the AP 170a, 170b. The AP 170a, 170b, and WTRU 102d, 102e, 102f, 102g, may be configured to use L2 broadcast based service discovery to send and receive the service digest 816. The service digest 816 may not include all the services 206a, 206b, 206c, available by the AP 170a, 170b.

The method 800 may continue with the WTRU 102d, 102e, 102f, 102g, initiating a PAD session request 804. The PAD session request 804 as illustrated in FIG. 8B may include a WTRU identifier 818, session identifier (ID) 820, and service identifier 822. Examples of a WTRU identifier 818 include a MAC ID and a random generated value.

The WTRU identifier 818 may also include the public identification information required to initiate authentication to the DIS 208a, 208b, 208c. The session identifier 820 may just be a random generated value. The service identifier 822 may be a value or name, which indicates the service 206a, 206b, 206c, the WTRU 102d, 102e, 102f, 102g, is interested in discovering or receiving information regarding. The WTRU 102d, 102e, 102f, 102g, may use information derived from the service digest 816 to determine the value of the service identifier 822.

The method 800 may continue with the AP 170a, 170b, determining whether or not to service the PAD session request 806. In some embodiments, the AP 170a, 170b, may be configured to determine whether or not to service the PAD session request 804 based on a load of the AP 170a, 170b, and whether or not the AP 170a, 170b, determines that it can service the PAD session request 804. In some embodiments, the AP 170a, 170b, may determine whether or not to service the PAD session request 804 based on the WTRU identifier 818 or the session identifier 820.

If the AP 170a, 170b, determines to service the PAD session request 804 the method 800 may continue with the AP 170a, 170b, sending a PAD session initiate 808 to the DIS 208a, 208b, 208c. The PAD session initiate 808 may include the identifying information of the AP 170a, 170b. The identifying information may be a session id for the AP 170a, 170b, which may be different from the session identifier 820 used by the WTRU 102d, 102e, 102f, 102g. The AP 170a, 170b, may be configured to keep a unique correspondence between the WTRU 102d, 102e, 102f, 102g, session identification 820 and the AP 170a, 170b, session identifier with the DIS 208a, 208b, 208c.

In some embodiments, the WTRU identifier 818 may be included in the PAD Session Initiate message 808. In some embodiments, the WTRU identifier 818 may not be needed at all. In some embodiments, the WTRU identifier 818 may be requested by the DIS 208a, 208b, 208c, as part of the follow-up exchange.

The method 800 may continue with a WTRU-DIS PAD exchange 810 between the WTRU 102d, 102e, 102f, 102g, and the DIS 208a, 208b, 208c. The AP 170a, 170b, may act as a transparent relay. In some embodiments, the AP 170a, 170b, is configured to use one protocol for the messages from the DIS 208a, 208b, 208c, to the AP 170a, 170b, and another protocol from the AP 170a, 170b, to the WTRU 102d, 102e, 102f, 102g.

In some embodiments, the WTRU 102d, 102e, 102f, 102g, and AP 170a, 170b, encapsulation may include ANQP. In some embodiments, the WTRU 102d, 102e, 102f, 102g, and AP 170a, 170b, encapsulation may be a protocol defined on top of GAS. In some embodiments, the AP 170a, 170b, and DIS 208a, 208b, 208c, encapsulation may include one or more of the protocols RADIUS, DIAMETER, or 802.21.

The method 800 may continue with PAD session complete 812. In some embodiments, the WTRU-DIS PAD exchange 810 is transparent to the AP 170a, 170b. In some embodiments, the DIS 208a, 208b, 208c, terminates the session with AP 170a, 170b.

The method 800 may continue with the AP 170a, 170b, sending a PAD session terminate 814 to the WTRU 102d, 102e, 102f, 102g. In some embodiments, the method 800 uses a protocol with a defined EtherType, which may facilitate communications between the WTRU 102d, 102e, 120f, 102g, and the DIS 208a, 208b, 208c, transparently to the AP 170a, 170b. In some embodiments, a new type for EtherType is defined for the protocol used in method 800. In some embodiments, an existing EtherType protocol, for example EAP or 802.21, is modified for PAD discovery, and the modified EtherType protocol is used rather than defining a new EtherType protocol.

In some embodiments, the service digest 816 may be used to control the number of PAD sessions that an AP 170a, 170b, supports and thus control the traffic overhead introduced by PAD service discovery. In some embodiments, when the AP 170a, 170b, is configured to control the number of valid PAD session requests 804, denial of service (DoS) attacks based on using a PAD session request 804 may fail, since the DoS would be limited in the number of valid PAD session requests 804 to start PAD sessions.

In some embodiments, the AP 170a, 170b, broadcasts one or several request identifiers as part of a service digest 816. In some embodiments, a WTRU 102d, 102e, 102f, 102g, which wishes to initiate a PAD service discovery session must use one of the broadcast identifiers as the session ID 820, which may be fixed for the duration of the PAD service discovery session. In some embodiments, if two or more WTRUs 102d, 102e, 102f, 102g, simultaneously use the same session ID 820 to make PAD session requests 804, the AP 170a, 170b, rejects all but one of these PAD session requests 804. The AP 170a, 170b, may be configured to cease to broadcast the session ID 820 once the session ID 820 is used. The one or more WTRUs 102d, 102e, 102f, 102g, whose PAD session requests 804 are rejected may listen for a new service digest 816 and select a new session ID 820 before initiating a PAD session request 804. In some embodiments, the WTRUs 102d, 102e, 102f, 102g, may use a back off procedure to determine how long to wait before sending a PAD session request 804.

In some embodiments, the AP 170a, 170b, may control the amount of PAD service discovery traffic by controlling the number of session IDs 820 broadcast in the service digest 816. In some embodiments, the AP 170a, 170b, may discontinue all PAD service discovery traffic by ceasing to broadcast any session IDs 820.

In some embodiments, EAPOL is used for EAP transport; the PAD session request 804 can be carried using EAPOL-Start, where a new TLV type is defined for service discovery requests. An EAP exchange with EAP-Request/identity sent directly to the WTRU 102d, 102e, 102f, 102g, may then be used for PAD discovery.

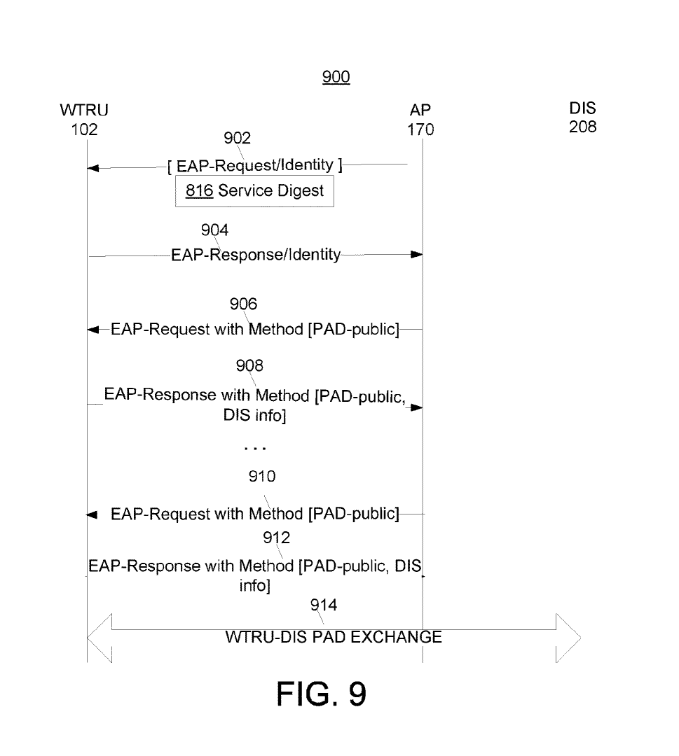

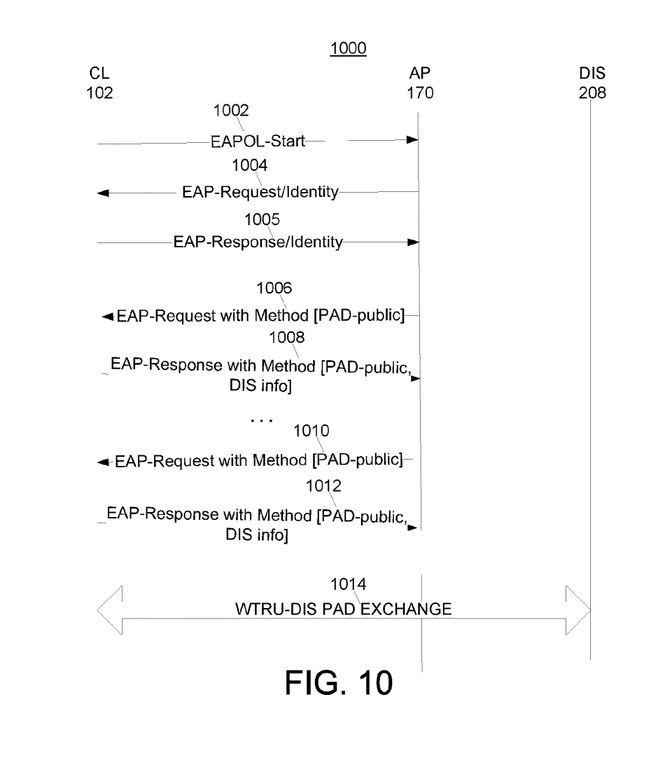

FIG. 9 illustrates a method of PAD discovery where a PAD session ID is broadcast using a session digest according to some disclosed embodiments. The AP 170a, 170b, illustrated in FIGS. 9 and 10 may refer to both the network management 167a, 167b of the WLAN 160a, 160b, and to the transmit and receive functionality of the AP 170a, 170b. For example, the network management 167a, 167b, may be configured to intercept and interpret higher layer packets such as IP and HTTP. The network management 167a, 167b, or portions of the network management 167a, 167b, may be incorporated into the AP 170a, 170b; or, the AP 170a, 170b, may forward the messages to the network management 167a, 167b, which then sends messages back to the AP 170a, 170b.

The AP 170a, 170b, may need to establish which DIS 208a, 208b, 208c, the WTRU 102d, 102e, 102f, 102g, is attempting to contact. In some embodiments, it is not possible to define a method for each PAD discovery request for EAP due to the number of potential DISs 208a, 208b, 208c, and number of possible method definitions for EAP.

Two alternatives are disclosed for beginning a PAD session the first illustrated in FIG. 9 and the second one illustrated in FIG. 10.

The first alternative uses a session ID 820 from the session digest 816. The method 900 may begin with EAP-Request/Identity 902. The method 900 may continue with EAP-Response/Identity 904. The EAP-Response/Identity 904 may be transported in an EAPOL-EAP PDU in an IEEE 802 based system. The AP 170a, 170b, may be configured to identify the EAP-Response/Identity 904 as a PAD session request by examining the EAP session identifiers in the EAP-Response/Identify 904. If EAPOL is used for EAP transport, then the EAPOL-start may not be sent by the WTRU 102d, 102e, 102f, 102g, prior to the EAP-Response/Identify 904 being sent to the AP 170a, 170b. The AP 170a, 170b, may be configured to generate EAPOL-Start for identifiers associated with PAD sessions. The WTRU 102d, 102e, 102f, 102g, may be configured to process EAPOL-EAP messages from the service digest 816 without having issued an EAPOL-start. The remainder of the method 900 will be disclosed after the second alternative for beginning a PAD session is disclosed in association with FIG. 10.

FIG. 10 illustrates a method for PAD discovery where EAPOL start is used according to some disclosed embodiments. Illustrated in FIG. 10 is the second alternative for beginning a PAD session where the WTRU 102d, 102e, 102f, 102g, may not use the session ID 820 from the session digest 816. If EAPOL is used for EAP Transport, the session request can be carried using EAPOL-Start 1002, where a new TLV type may be defined for service discovery requests. A typical EAP exchange with EAP-Request/identity 1004 sent directly to the WTRU 102d, 102e, 102f, 102g, may be used with a new TLV type. The WTRU 102d, 102e, 102f, 102g, will respond with an EAP-Response/Identity 1005.

Once the PAD session has started using one of the two alternatives disclosed above in FIG. 9 and FIG. 10, the methods 900 and 1000 continue with EAP-request with method [PAD-public] 906, 1006. In some embodiments, a single EAP method is used to indicate that a PAD procedure is being use as in 906, 1006. The EAP method may be of a type PAD-public as illustrated in FIGS. 9 and 10.

The methods 900 and 1000 continue with EAP-response with method [PAD-public, DIS info] 908, 1008. The WTRU 102d, 102e, 102f, 102g, responds to message 906, 1006 with an EAP-Response with Method, indicating the name of the DIS 208 in the DIS info which is a Type-Data field.

In some embodiments, the Type-Data field is limited for EAP implementations to about 1020 octets. The DIS info may include vendor-specific DIS identifiers and generic description languages, for example XML, may need to be supported. The DIS info may be larger than 1020 octets and not fit into a single Type-Data field. In some embodiments, the Type-Data field includes a flag to indicate to the AP 170a, 170b, that the WTRU 102d, 102e, 102f, 102g, has more data or that the WTRU 102d, 102e, 102f, 102g, response is complete, which will cause the AP 170a, 170b, to generate another EAP-Request with Method request 910, 1010 to the WTRU 102d, 102e, 102f, 102g, for the transmission of more DIS info. The WTRU 102d, 102e, 102f, 102g, response 912, 1012 may indicate with the flag that even more DIS info needs to be sent, in which case the AP 170a, 170b, will repeat the process and send another EAP-Request with Method [PAD-public] 910, 1010. The methods 900 and 1000 may continue with the CL-DIS PAD EXCHANGE 914, 1014. The AP 170a, 170b, may be configured to associate a session ID with the destination DIS for routing EAP messages. The CL-DIS PAD EXCHANGE 914, 1014 may be terminated in a similar manner as in method 800. In some embodiments, the methods 900 and 1000 have at least two additional steps compared with the method 800.

In some embodiments, Generic Advertisement Protocol (GAS) is used. In some embodiments, a new GAS-based protocol is used by reserving a new GAS protocol value. In some embodiments, a service 206a, 206b, 206c that is an 802.21 media independent handoff (MIH) Information Service is defined, which has the benefit of having both a GAS Protocol Value and an EtherType.

In some embodiments, a second PAD-related EAP method, EAP-Private is defined. The AP 170a, 170b, may be configured to forward EAP packets to the DIS 208a, 208b, 208c, without examining packets when the EAP-Private method is indicated. The AP 170a, 170b, may be configured to encapsulate the EAP packets from the WTRU 102d, 102e, 102f, 102g, without examining the packets when EAP-Private method is indicated. The AP 170a, 170b, may encapsulate the packets using another protocol such as RADIUS, DIAMETER to the DIS 208a, 208b, 208c, and to encapsulate the packets from the DIS 208a, 208b, 208c, to the WTRU 102d, 102e, 102f, 102g, using EAPOL. The methods 900 and 1000 may be used to access DISs 208a, 208b, 208c, that are remote.

In some embodiments, the AP 170a, 170b, provides open access from the WTRU 102d, 102e, 102f, 102g, to the AP 170a, 170b, so that a WTRU 102d, 102e, 102f, 102g, capable of communicating with the AP 170a, 170b, may be permitted to initiate a PAD method with the AP 170a, 170b, with authentication. In some embodiments, WTRUs 102d, 102e, 102f, 102g, may identify them selves to the AP 170a, 170b, but the identity may be unauthenticated. WTRU 102d, 102e, 102f, 102g, identities may include a MAC ID or an arbitrarily generated one-time value. In some embodiments, PAD discovery communication between the WTRU 102d, 102e, 102f, 102g, and the AP 170a, 170b, is not secured. In some embodiments, well-known techniques for link-security and device security may be utilized by the WTRU 102d, 102e, 102f, 102g, and the AP 170a, 170b. An example of a PAD discovery is the WTRU 102d, 102e, 102f, 102g, requesting a publicly known value such as a service name.

In some embodiments, authenticated security may be required between the DIS 208a, 208b, 208c, the AP 170a, 170b, and the WTRU 102d, 102e, 102f, 102g. For example, when the DIS 208a, 208b, 208c, provides the WTRU 102d, 102e, 102f, 102g, with service-specific access credentials for the given AP 170a, 170b.

In some embodiments, a form of security is used that requires an assurance that all the packets associated with the same session originate at the same terminal, for example WTRU 102d, 102e, 102f, 102g, or DIS 208a, 208b, 208c. In some embodiments, the AP 170a, 170b, is transparent to the WTRU 102d, 102e, 102f, 102g, and DIS 208a, 208b, 208c, communication. In some embodiments, to permit the WTRU 102d, 102e, 102f, 102g, to conduct PAD using the AP 170a, 170b, the AP 170a, 170b, requires only the following information WTRU 102d, 102e, 102f, 102g, identity in a loose sense, DIS 208a, 208b, 208c, identity in a loose sense, and discovery session information. In some embodiments, the following set of discovery session commands may be used start, terminate, request, and response.

In some embodiments, generic service identification is provided. For example, the WTRU 102d, 102e, 102f, 102g, may be able to identify the DIS 208a, 208b, 208c, using a generic name which the WTRU 102d, 102e, 102f, 102g, and DIS 208a, 208b, 208c, have pre-agreed on. If the AP 170a, 170b, is aware of the generic name, it should be able to determine a means of communication with DIS 208a, 208b, 208c, based on this generic name only. Otherwise, in some embodiments, the AP 170a, 170b, terminates the discovery session with an appropriate error message to the WTRU 102d, 102e, 102f, 102g.

In some embodiments, the protocol used for indirect discovery is identifiable as a higher layer protocol by at least the key L2 technologies, these being the collection of 802 MACs and 3GPP. In some embodiments, a supported 3GPP protocol or standards modification is used for the indirect discovery.

In some embodiments, if appropriate WTRU-DIS security is used, man-in-the-middle attacks by the AP 170a, 170b, are preventable by the WTRU-DIS security.

In some embodiments, a globally standardized service naming convention is not used. In some embodiments, a set of globally standardized service names is used. For example, a service name lookup service, DNS for service names may be used. In some embodiments, the service provider loads its service name into the AP 170a, 170b. The loaded name is then private to the service provider and does not need to follow any globally agreed on conventions.

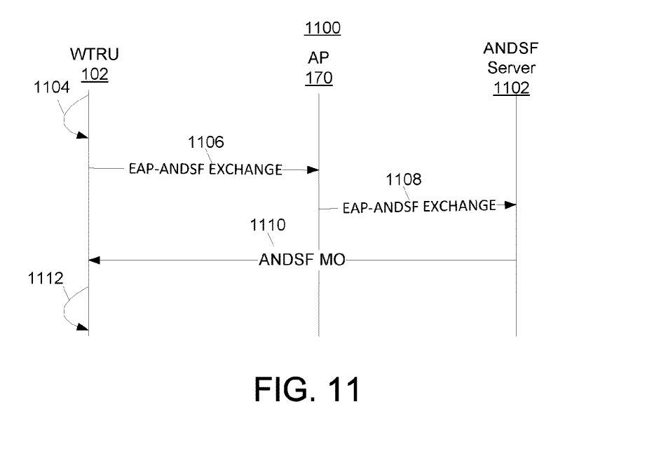

FIG. 11 illustrates a method according to some disclosed embodiments. The AP 170a, 170b, illustrated in FIG. 11 may refer to both the network management 167a, 167b of the WLAN 160a, 160b, and to the transmit and receive functionality of the AP 170a, 170b. For example, the network management 167a, 167b, may be configured to intercept and interpret higher layer packets such as IP and HTTP. The network management 167a, 167b, or portions of the network management 167a, 167b, may be incorporated into the AP 170a, 170b; or, the AP 170a, 170b, may forward the messages to the network management 167a, 167b, which then sends messages back to the AP 170a, 170b.

The method 1100 may begin with the WTRU 102d, 102e, 102f, 102g, selecting an AP 170a, 170b, to send a message to. In some embodiments, the WTRU 102d, 102e, 102f, 102g, selects an AP 170a, 170b that allows EAP-based exchange with an ANDSF server 1102 that the WTRU 102d, 102e, 102f, 102g, can obtain a policy from. The mobile operator which the WTRU 102d, 102e, 102f, 102g, subscribes to may maintain one or more ANDSF servers 1102 that can serve the given WTRU 102d, 102e, 102f, 102g. A new EAP method may be defined EAP-ANDSF for the WTRU 102d, 102e, 102f, 102g, to acquire the provisioned MO from the ANDSF server 1102.

In some embodiments, the AP 170a, 170b, may advertise the availability of ANDSF servers 1102 over a beacon frame. In some embodiments, the WTRU 102d, 102e, 102f, 102g, and AP 170a, 170b, may exchange packets according to ANQP to determine whether or not the AP 170a, 170b, provides access to the ANDSF server 1102 of the mobile operator the WTRU 102d, 102e, 102f, 102g, is interested in querying. In some embodiments, the ANDSF servers 1102 are identified by name as defined in the appropriate standard for names of ANDSF servers 1102. In some embodiments, the WTRU 102d, 102e, 102f, 102g, uses ANQP to discover whether or not the AP 170a, 170b, supports EAP-ANDSF and the list of ANDSF servers 1102 to which the AP 170a, 170b, allows access, or alternatively whether the AP 170a, 170b, allows access to the ANDSF server 1102 that the WTRU 102d, 102e, 102f, 102g, is interesting in accessing.

The method 1100 may continue with EAP-ANDSF Exchange 1106. The WTRU 102d, 102e, 102f, 102g, may initiate an EAP-based exchange with the AP 170a, 170b, which is not illustrated. The WTRU 102d, 102e, 102f, 102g, may send a message to initiate an EAP-ANDSF exchange 1106. In some embodiments, the WTRU 102d, 102e, 102f, 102g, authenticates with the AP 170a, 170b, but does not associate with the AP 170a, 170b, or obtain an IP address from the AP 170a, 170b. In some embodiments, EAP over LAN Ethertype is used. In some embodiments, a new Ethertype is defined to transport the discovery protocol.

In some embodiments, the WTRU 102d, 102e, 102f, 102g, does not associate with the AP 170a, 170b. In some embodiments, the GAS protocol is modified to carry EAP request/response messages. In some embodiments, the EAP responses are mapped to the GAS query message from the WTRU 102d, 102e, 102f, 102g, and EAP requests are mapped to GAS advertising responses. In some embodiments, the GAS protocol is modified differently to accommodate the discovery of the ANDSF management object (MO.)

In some embodiments, because the GAS protocol is designed for communication with an advertisement server as its destination, an EAP-ANDSF method may allow EAP-ANDSF peer-level communication termination at the AP 170a, 170b, or at another entity. In some embodiments, the EAP-ANDSF 1106 may terminate at the AP 170a, 170b, or another entity of the network. In this case, either the AP 170a, 170b, or the other entity of the network may take over communication with the ANDSF server 1102. For example, as illustrated in FIG. 11, the AP 170a, 170b, sends a message EAP-ANDSF 1108 to the ANDSF server 1102. Both 1106 and 1108 may involve multiple communications. In some embodiments, the other network entity may be an ANDSF proxy server (not illustrated) associated with the local area network of the AP 170a, 170b.

In some embodiments, the GAS protocol may terminate directly at the ANDSF server 1102 so that the ANDSF server 1102 is acting as an advertising server for GAS. Thus, EAP-ANDSF 1106 would pass through the AP 170a, 170b, and terminate at the ANDSF server 1102.

The method continues with ANDSF MO exchange 1110. An MO may be provisioned and sent to the WTRU 102d, 102e, 102f, 102g. The MO may be an abbreviated version of a full MO. In some embodiments, the AP 170a, 170b, or another network entity may receive the ANDSF MO 1110 and send it to the WTRU 102d, 102e, 102f, 102g.

The method may continue with 1112. The WTRU 102d, 102e, 102f, 102g, may determine whether or not based on the provisioned MO to proceed with authentication, and in some embodiments association, with the WLAN 160a, 160b associated with the AP 170a, 170b, or select and accesses a different WLAN 160a, 160b.

In some embodiments, the EAP-ANDSF is defined as an EAP method, and has an EAP method number either proprietary or registered with Internet Assigned Numbers Authority (IANA). The EAP-ANDSF protocol or method may, in some embodiments, operates as follows: the EAP request/response exchange is used to carry protocol messages for a security protocol described in the 3GPP security protocols for evolved packet core identified as being permitted as a security mechanism for ANDSF. Because EAP allows multiple rounds of request/response, the full protocol, for example https, or open mobile alliance (OMA) device management (DM) bootstrap, may be implemented.

Upon successful completion of security establishment with the ANDSF server, the ANDSF server may indicate success using an EAP request message instead of an EAP success message. The WTRU 102d, 102e, 102f, 102g, may now use an EAP response message to request the appropriate MO. The ANDSF server may supply the MO using EAP request messages. Because EAP requires a response for each request, the UE may produce a response to each such request. The response may be empty, for example carry no information for ANDSF, or it may contain requests for further information, for example more MO, or an indication that all the necessary information has been received and the communication can stop.

Once the ANDSF MO is provisioned on the WTRU 102d, 102e, 102f, 102g, the ANDSF server issues an EAP success and/or EAP failure message. Both may terminate the EAP exchange with the WTRU 102d, 102e, 102f, 102g. If the WTRU 102d, 102e, 102f, 102g, was associated with the AP 170a, 170b, it will have to either disassociate from the AP 170a, 170b, or initiate a second EAP exchange to actually authenticate to it. In some embodiments, an EAP failure message is preferred as the AP 170a, 170b, will take this as a normal case, although usage of EAP success is permitted. In some embodiments, if a non-associated approach, for example GAS, was used to access the ANDSF, then the choice of EAP failure or success may not relevant.

In some embodiments, the services are defined with a hierarchy. For example, a top level may be a service category, for example, printers, video, VPN, gaming, and one or more detailed levels may be added under the service category. For example, a service category of printer may have service descriptions of 3D printer, color printer, printer model.

In another example, the Service Descriptions for printer may be printer type is color, black, white, or 3D printer; and, fee of printer to be paid or free. Another example may be for service category to be video, and the service description to be streaming, pre-paid, etc. As another example, service category may be gaming, and the service description may be multi-players, card games, human vs. computer, etc. In some embodiments, the service descriptions may have sub-categories as well. For example, multi-players may have further sub-categories of first person shoot, strategy board games, etc.

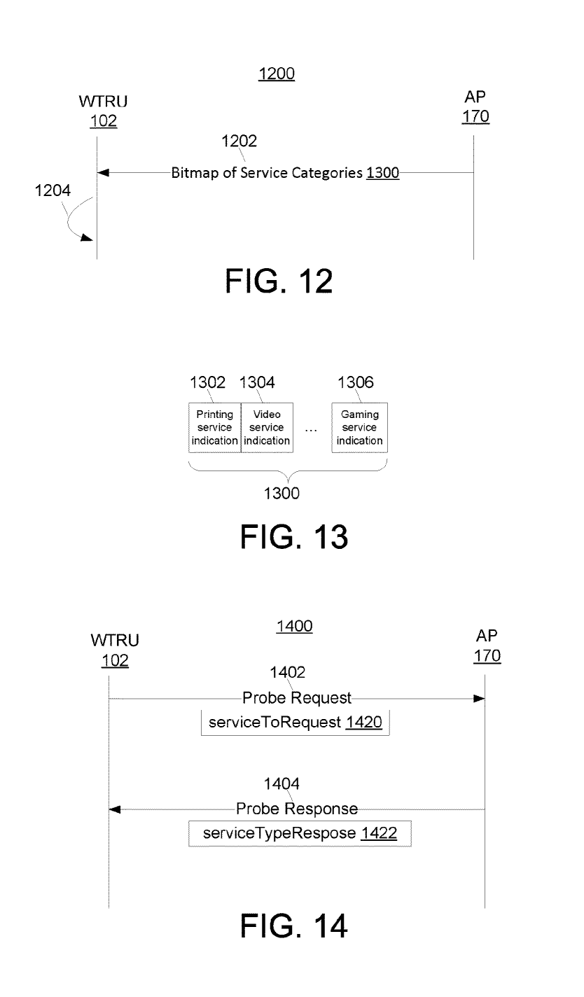

FIG. 12 illustrates a method according to some disclosed embodiments. FIG. 13 illustrates a bitmap of service categories. The AP 170a, 170b, illustrated in FIG. 12 may refer to both the network management 167a, 167b of the WLAN 160a, 160b, and to the transmit and receive functionality of the AP 170a, 170b. For example, the network management 167a, 167b, may be configured to intercept and interpret higher layer packets such as IP and HTTP. The network management 167a, 167b, or portions of the network management 167a, 167b, may be incorporated into the AP 170a, 170b; or, the AP 170a, 170b, may forward the messages to the network management 167a, 167b, which then sends messages back to the AP 170a, 170b.

In some embodiments, the bitmap of service categories 1300 may include printing service indication 1302, video service indication 1304, and gaming service indication 1306. A 1 may be used to indicate that via the AP 170a, 170b, some service is provided with the service category indicated. For example, a 1 in the bitmap of service categories 1300 in the printing service indication 1302 may indicate that printing services are available through the AP 170a, 170b. In some embodiments, the service categories printing service indication 1302, video service indication 1304, gaming service indication 1306 may be represented differently in the service categories 1300. The service categories 1300 may be a subset of available service categories 1300 selected based on a criteria such as services that are most frequently requested by WTRUs 102d, 102e, 102f, 102g, services that the AP 170a, 170b, is trying to sell, etc. In some embodiments, the AP 170a, 170b, may charge a fee to include a service in the service categories 1300.

The method 1200 may begin with the AP 170a, 170b, sending a frame 1202 to the WTRU 102d, 102e, 102f, 102g that includes a bitmap of service categories 1300. In some embodiments, the frame 1202 may be a special-purpose beacon, for example, the beacon may be sent at a less frequent interval than a normal beacon, which is usually sent every 100 ms. In some embodiments, the AP 170a, 170b, broadcasts the service categories 1300 or a subset of the service categories in a broadcast or multicast frame, for example the beacon, short beacon, FILS discovery or broadcast probe response frame. In some embodiments, the frame 1202 can be carried using public action frames, which can be sent periodically or upon some trigger. In some embodiments, the bitmap of service categories 1300 can be sent on an extended capability information field, where the bitmap of service categories 1300 could be included.

Optionally, the method 1200 may continue at 1204 with the WTRU 102d, 102e, 102f, 102g, may examine the bitmap of service categories 1300. For example, the connection manager of the WTRU 102d, 102e, 102f, 102g, which may currently be displaying the list of available APs 170a, 170b, with their associated SSID and signal strength can also display or process information about the services categories available at the AP based on the service categories 1300. In some embodiments, the WTRU 102d, 102e, 102f, 102g, may perform incremental discovery based on the received service categories 1300 using a known method or a method disclosed herein. For example, the WTRU 102d, 102e, 102f, 102g, may be interested in printing services and printing service indication 1302 may indicate that printing services are available. The WTRU 102d, 102e, 102f, 102g, may then send another message to obtain more specific information regarding the printing services that are available via the AP 170a, 170b. In some embodiments, a user may select which AP 170a, 170b, to send an inquiry to regarding further information about printing services.

FIG. 14 illustrates a method according to some disclosed embodiments. The method 1400 may begin with the WTRU 102d, 102e, 102f, 102g, sending a probe request MLME-Scan.request 1402, which may include a serviceToRequest 1420. In some embodiments, the probe request may be a MLME-Scan.request. In some embodiments, a different frame type other than an MLME may be used. The serviceToRequest 1420 is disclosed in Table 1 and Table 2, according to some disclosed embodiments.

In some embodiments, as illustrated in Tables 1 and 2, a new field ServiceToRequest is added to the MLME-Scan.request primitive.

TABLE 1
ServiceToRequest added to the MLME-Scan.request primitive

| Name | Type | Valid Range | Description |
|---|---|---|---|
| ServiceToRequest | Bitmap | Predefined K | The bitmap indication |
| | or | bits | of a service type or high |
| | enumeration | | level of service category |
| | | | that the UE wants to |
| | | | request. |

TABLE 2
ServiceToRequest to the Probe Request Frame

| Order | Information | Notes |
|---|---|---|
| 14 or last | ServiceToRequest | The bitmap indication of a service |
| | | type or high level of service category |
| | | that the STA want to request. |

In some embodiments, the WTRU 102d, 102e, 102f, 102g, may receive a MLME-Scan.request primitive indicating a service type or service category, the WTRU 102d, 102e, 102f, 102g, may generate the probe request 1402 based on receiving the MLME-Scan.request primitive.

The method 1400 may continue with the AP 170a, 170b, sending a probe response 1404 to the WTRU 102d, 102e, 102f, 102g. The probe response 1404 may include serviceTypeResponse 1422. The serviceTypeResponse 1422 is disclosed in Tables 3 and 4, according to some disclosed embodiments.

TABLE 3
ServiceTypeResponse added to the Probe Response Frame

| Order | Information | Notes |
|---|---|---|
| 55 or last | ServiceTypeResponse | If a specific Service type is queried |
| | | in the received Probe Request, this |
| | | field can be a simple indication of |
| | | availability of the queried service |
| | | (yes or no); If a high level of service |
| | | category is queried in the received |
| | | Probe Request, this field will include |
| | | more detailed description of the |
| | | service types it provide under the |
| | | queried high level service |
| | | category. |

TABLE 4
ServiceTypeResponse added to the MLME-Scan.confirm Primitive

| | | Valid | |
|---|---|---|---|
| Name | Type | Range | Description |
| ServiceType | Type of | N/A | If a specific Service type is |
| Response | service | | queried in the received Probe |
| | | | Request, this field can be a |
| | | | simple indication of availability |
| | | | of the queried service (yes or no); |
| | | | If a high level of service category |
| | | | is queried in the received Probe |
| | | | Request, this field will include |
| | | | more detailed description of the |
| | | | service types it provide under the |
| | | | queried high level service |
| | | | category. |

In some embodiments, upon completion of active scanning or passive scanning, a MLME-Scan.confirm primitive will be generated and sent to the WTRU 102d, 102e, 102f, 102g, indicating a particular service type or service category is available or not and may include associated detailed information.

In some embodiments, the method 1400 may continue with a second level of service discovery where the WTRU 102d, 102e, 102f, 102g, may send another probe request 1402 for more details regarding one or more particular service categories or service descriptions.

In some embodiments, the probe request 1402 and probe response 1404 may be carried out quickly because the AP 170a, 170b, may not need to query the IS or Advertisement Server as the AP 170a, 170b, may store some service information locally, and because information regarding the service may be exchanged using a bit map.

In some embodiments, the method 1400 may include the WTRU 102d, 102e, 102f, 102g, receiving a frame 1202 prior to sending the probe request 1402. The WTRU 102d, 102e, 102f, 102g, may determine the probe request 1402 based on the received frame 1202.

In some embodiments, the AP 170a, 170b, is configured to send information regarding the highest level or service category in every one out of M1 broadcast management frames such as beacon frame as an optional IE. In some embodiments, the starting offset is O1 broadcast management frame intervals such as beacon intervals.

In some embodiments, the AP 170a, 170b, is configured to send the second level of service type related information in every one out of M2 broadcast management frames such as beacon frame as an optional IE. In some embodiments, the starting offset is O2 broadcast management frame intervals such as beacon intervals. In some embodiments, the value of M2 is an integer multiple of M1. In some embodiments, the value of O2 is chosen appropriately so that the broad frames carrying the second level of service information will not overlap with those carrying the first level of service information.

In some embodiments, there are k levels of service related information in a hierarchy of service related information, and the kth level of service type related information is transmitted in every one out of Mk beacon frames as optional IE. In some embodiments, the starting offset is Ok beacon intervals. The value of Mk may be an integer multiple of Mk-1. And the value of Ok may be chosen appropriately so that the beacon frames carrying the kth level of service information will not overlap with those carrying the higher level of service information.

The WTRU 102d, 102e, 102f, 102g, may listen to the broadcast management frames such as beacon frames that carry the highest level or first level of service type information. If the preferred service type of the WTRU 102d, 102e, 102f, 102g, is indicated available at the first level of service type information, then it may continue to listen to the next level. The WTRU 102d, 102e, 102f, 102g, may continue doing so until either the service type information does not meet the need for service of the WTRU 102d, 102e, 102f, 102g, or the WTRU 102d, 102e, 102f, 102g, obtains enough detail of the service provided by the AP 170a, 170b.

In some embodiments, the AP may broadcast for mmW specific services. Services which require an exceptionally high service data throughput may benefit from the use of services over mmW air interface such as that supported by 802.11ad. In some embodiments, service discovery of services over mmW air interface may be performed using the beacons with an indication of services specifically available over an mmW air interface using 802.11ad. For example if high definition video is available on a mmW channel an indication may be made on the 802.11ac beacon.

In some embodiments, the 802.11ad beacon's range is limited using the semi-omni transmission mode, and in some embodiments the beacon may be used to provide very location specific application service information. Thus, pre-association of service discovery for services delivered on mmW devices such as 802.11ad may be performed.

In some embodiments, a HASH tag in an identity string of the beacon frame may be used. The HASH tag may be used to advertise support for certain application families, examples of these families include: social networks, social circles, music library, video library, GPS/location assistance, audio/video streaming, telephony, etc.

In some embodiments, the use of location parameters, and related location specific venues, may be used as an indication for the availability of, and/or indication of methods to retrieve, specific application services. In some embodiments, application services may be associated with specific VHT capabilities. For example some services such as streaming video may require a high data rate which can only be supported by certain capability categories.

In some embodiments, a device class may be associated with a specific type of application. For example a printer which advertises its services may be restricted to only providing printing services. In some embodiments, a location of the printer may be provided, or a name of the printer. The location of the printer may be useful to the user of the WTRU 102d, 102e, 102f, 102g. Location information of the printer may be managed by a central database in a WLAN controller which facilitates the advertisement of location sensitive services through connected device AP's. In some embodiment, the printer may store a location of the printer using GPS or a user entered location.

A probe request may be used to inquire of an AP 170a, 170b, which services are available via the AP 170a, 170b. The AP 170a, 170b, may respond in a probe request response with more detailed information. For example, the availability of specific API interfaces may be disclosed in the probe response. In some embodiments, a probe request for information regarding application services may be sent in response to a capability field in the beacon frame. Since the number of applications can be very large, and all known application developments may not be known, the above disclosed methods provide an extensible and scalable identification scheme for a WTRUs 102d, 102e, 102f, 102g, to discover applications information regarding the applications.

In some embodiments, a WTRUs 102d, 102e, 102f, 102g, may send service information to an AP 170a, 170b, and the AP 170a, 170b, may advertise the services provided by the WTRU 102d, 102e, 102f, 102g. In some embodiments, the AP 170a, 170b, may advertise the service of the WTRU 102d, 102e, 102f, 102g, through beacon frames using capability field or another field.

In some embodiments, a WTRU 102d, 102e, 102f, 102g, may use the probe request and probe response frames to advertise services available through the WTRU 102d, 102e, 102f, 102g, to the AP 170a, 170b, or to notify the AP 170a, 170b, that services are no longer available. In some embodiments, the AP 170a, 170b, may respond to the WTRU 102d, 102e, 102f, 102g, with services that the AP 170a, 170b, would like the WTRU 102d, 102e, 102f, 102g, to use.

In some embodiments, a group of WTRUs 102d, 102e, 102f, 102g, may advertise the capability to support services to the AP 170a, 170b. A group ID mechanism may be used instead of a WTRU ID to advertise the services and to notify the AP 170a, 170b, of the services available.

In some embodiments, an AP 170a, 170b, may advertise D2D services that are available. In some embodiments, D2D service discovery may be facilitated by a probe request, probe response, frame exchange with the AP 170a, 170b, at the same time a D2D beacon exchange between non-AP terminals.

In some embodiments, services advertised using beacon frames as described may direct an 802.11ad capable device to initiate a D2D service discovery session using an 802.11ad spatial sharing session.

Services discovered at a macro range may not be fully available in a macro network. In some embodiments, a beacon advertised in an 802.11ah network may include an indication of the capability dependency for the service. For example, services may be defined in a hierarchical fashion wherein services at a cell edge may be incremental, and restricted in capability, relative to those provided closer to the AP 170a, 170b.

In some embodiments, methods which allow the seamless transition to additional capabilities as a WTRU 102d, 102e, 102f, 102g, moves closer to an AP 170a, 170b, may be supported by an indication in the beacon transmissions from the AP 170a, 170b. For example the AP 170a, 170b, may monitor a location of the WTRU 102d, 102e, 102f, 102g, and use this location information to provide an indication to the WTRU 102d, 102e, 102f, 102g, when additional capabilities are supported. In some embodiments, when supporting the transition of services from a cellular network, to a WLAN 160a, 160b, macro coverage network using 802.11ah, a capabilities field may indicate that the request for services originates in a cellular network request. In some embodiments, a service request that originates from a cellular network may be given a higher priority than other service requests. In some embodiments, an 802.11ah beacon may be used to broadcast location specific services to a macro coverage area. In some embodiment, WTRUs 102d, 102e, 102f, 102g, which receives this broadcast may use the location specific information to provide an indication to the user of location specific services.

In some embodiments, a 802.11ah beacon may in addition provide service discovery information that is available on an associated 802.11ac or 802.11ad network within its coverage area. In some embodiments, WTRUs 102d, 102e, 102f, 102g, may use this information to prepare for a transition to an 802.11ac or 802.11ad network to receive services.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, STA, client, terminal, base station, RNC, or any host computer.

What is claimed:

1. A method for use in a wireless transmit and receive unit (WTRU), the method comprising:
obtaining an Internet Protocol (IP) address to communicate with a wireless local area network (WLAN) before associating with the WLAN for the purpose of pre-association discovery (PAD) through the WLAN.

2. The method of claim 1, wherein obtaining the IP address further comprises:
obtaining the IP address by at least one of: randomly selecting the IP address from a space of IP addresses allocated for PAD, determining the IP address based on a broadcast frame from the WLAN, or sending an L2 discovery message to the WLAN and receiving the IP address in response to the L2 discovery message.

3. The method of claim 1, wherein the IP address is one of: a link-local IP address, or a static IP address.

4. The method of claim 1, further comprising:
sending a request including an information server name to a domain name server via the WLAN; and
receiving an IP address of the information server.

5. The method of claim 1, further comprising:
communicating with an information server to perform PAD discovery using the obtained IP address.

6. The method of claim 1, wherein the WTRU accesses the WLAN through at least one of: an access point (AP), base station (BS), or a second WTRU, and wherein the WLAN implements at least one of: 802.11, 802.15, or 802.16.

7. A method for use in a wireless local area network (WLAN), the method comprising:
receiving a message including a source IP address from an unassociated wireless transmit and receive unit (WTRU); and
restricting how the unassociated WTRU may use the source IP address.

8. The method of claim 7, wherein restricting further comprises:
restricting the use of the source IP address by at least one of the following: limiting an amount of time the source IP address can be used, limiting a quantity of traffic associated with the source IP address, limiting which addresses the unassociated WTRU can communicate with using the source IP address, or capturing messages from the unassociated WTRU and sending the captured messages to a PAD web server.

9. The method of claim 7, further comprising:
sending the IP address to the unassociated WTRU by at least one of the following: broadcasting the IP address in a beacon frame to the unassociated WTRU, or responding to an L2 discovery message from the unassociated WTRU by sending the unassociated WTRU the source IP address.

10. The method of claim 7, further comprising:
on a condition that the message includes a restricted destination IP address, then returning an error message to the unassociated WTRU.

11. The method of claim 7, wherein restricting further comprises:
restricting how the unassociated WTRU may the source IP address by permitting the unassociated WTRU to communicate with a domain name server local to the AP and with an information server, wherein an IP address of the information server is determined based on a request to the domain name server.

12. The method of claim 7, wherein receiving the message including the source IP address further comprises:
receiving the message including the source IP address from the unassociated WTRU through at least one of: an access point (AP), base station (BS), or a second WTRU, and wherein the WLAN implements at least one of: 802.11, 802.15, or 802.16.

13. A method for use in a wireless local area network (WLAN), the method comprising:
receiving a pre-association discovery (PAD) request from an WTRU; and
relaying messages between the WTRU and a remote information server (IS) for PAD information exchange, wherein the WTRU does not have an Internet protocol (IP) address for use with the WLAN and the WTRU is not associated with the WLAN.

14. The method of claim 13, wherein the WLAN uses a first protocol for the messages from the WTRU to the WLAN, and a second protocol from the WLAN to the IS.

15. The method of claim 13, further comprising:
sending a PAD session initiate request to the remote IS.

16. The method of claim 13, wherein the WTRU and WLAN use L2 addresses to communicate, and wherein the WLAN and the IS use Internet Protocol (IP) addresses to communicate.

17. The method of claim 13, wherein the PAD request comprises a valid session identification (ID), and wherein the WLAN controls a number of unassociated WTRUs communicating with the WLAN for the purpose of PAD by limiting a number of valid session IDs.

18. The method of claim of claim 13, wherein the messages are relayed through at least one of: an access point (AP), base station (BS), or a second WTRU, and wherein the WLAN implements at least one of: 802.11, 802.15, or 802.16.

19. A method for use in a wireless transmit and receive unit (WTRU) for pre-association discovery, the method comprising:
communicating with a remote information server (IS) by sending messages to an wireless local area network (WLAN) using an L2 address and receiving responses from the IS through the WLAN, wherein the WTRU is not associated with the WLAN.

20. The method of claim 19, further comprising:
sending a pre-association discovery (PAD) request to the WLAN.

21. The method of claim 19, wherein the IS and the WLAN communicate using Internet Protocol (IP).

22. The method of claim 19, further comprising:
receiving a service digest from the WLAN; and
determining whether or not to send the PAD request to the WLAN based on the service digest.

23. The method of claim 19, wherein the PAD request includes a service identifier that indicates a service for PAD.

24. The method of claim 19, wherein the messages are sent through at least one of: an access point (AP), base station (BS), or a second WTRU and wherein the WLAN implements at least one of: 802.11, 802.15, or 802.16.
